(19) United States
(12) Patent Application Publication
(10) Pub. No.: US 2007/0110089 A1
(43) Pub. Date: May 17, 2007

(54) System for intercepting multimedia documents

(75) Inventors: Hassane Essafi, Orsay (FR); Marc Pic, Paris (FR); Jean-Pierre Franzinetti, Gaillan En Medoc (FR); Fouad Zaittouni, Chelles (FR); Keltoum Oulahoum, Orsay (FR)

Correspondence Address: WEINGARTEN, SCHURGIN, GAGNEBIN & LEBOVICI LLP, TEN POST OFFICE SQUARE, BOSTON, MA, 02109, US

(73) Assignee: ADVESTIGO, Gif Sur Yvette Cedex (FR)

(21) Appl. No.: 10/580,765

(22) PCT Filed: Nov. 27, 2003
(86) PCT No.: PCT/FR03/03502

§ 371 Date: May 26, 2006

(51) Int. Cl. H04L 12/28

(52) U.S. Cl. 370/420

(57) ABSTRACT

The system for intercepting multimedia documents disseminated from a network comprises an interception module (110) for intercepting and processing information packets, which module comprises a packet interception module (101), a packet header analyzer module (102), a module (104) for processing packets recognized as forming part of a connection that has already been set up in order to access a storage container where the data present in each received packet is saved, and a module (103) for creating an automaton for processing received packets belonging to a new connection. The system further comprises a module for analyzing the content of the data stored in the containers, for recognizing the protocol used, for analyzing the content transported by said protocol, and for reconstituting the intercepted documents.

The present invention relates to a system for intercepting multimedia documents disseminated from a network.

The invention thus relates in general manner to a method and a system for providing traceability for the content of digital documents that may equally well comprise images, text, audio signals, video signals, or a mixture of these various types of content within multimedia documents.

The invention applies equally well to active interception systems capable of leading to the transmission of certain information being blocked, and to passive interception systems enabling certain transmitted information to be identified without blocking retransmission of said information, or even to mere listening systems that do not affect the transmission of signals.

The invention seeks to make it possible to monitor effectively the dissemination of information by ensuring effective interception of information disseminated from a network and by ensuring reliable and fast identification of predetermined information.

The invention also seeks to enable documents to be identified even when the quantity of information disseminated from a network is very large.

These objects are achieved by a system of intercepting multimedia documents disseminated from a first network, the system being characterized in that it comprises a module for intercepting and processing packets of information each including an identification header and a data body, the packet interception and processing module comprising first means for intercepting packets disseminated from the first network, means for analyzing the headers of packets in order to determine whether a packet under analysis forms part of a connection that has already been set up, means for processing packets recognized as forming part of a connection that has already been set up to determine the identifier of each received packet and to access a storage container where the data present in each received packet is saved, and means for creating an automaton for processing the received packet belonging to a new connection if the packet header analyzer means show that a packet under analysis constitutes a request for a new connection, the means for creating an automaton comprise in particular means for creating a new storage container for containing the resources needed for storing and managing the data produced by the means for processing packets associated with the new connection, a triplet comprising <identifier, connection state flag, storage container> being created and being associated with each connection by said means for creating an automaton, and in that it further comprises means for analyzing the content of data stored in the containers, for recognizing the protocol used from a set of standard protocols such as in particular http, SMTP, FTP, POP, IMAP, TELNET, P2P, for analyzing the content transported by the protocol, and for reconstituting the intercepted documents.

More particularly, the analyzer means and the processor means comprise a first table for setting up a connection and containing for each connection being set up an identifier “connectionId” and a flag “connectionState”, and a second table for identifying containers and containing, for each connection that has already been set up, an identifier “connectionId” and a reference “containerRef” identifying the container dedicated to storing the data extracted from the frames of the connection having the identifier “connectionId”.

The flag “connectionState” of the first table for setting up connections may take three possible values (P10, P11, P12) depending on whether the detected packet corresponds to a connection request made by a client, to a response made by a server, or to a confirmation made by the client.

According to an important characteristic of the present invention, the first packet interception means, the packet header analyzer means, the automaton creator means, the packet processor means, and the means for analyzing the content of data stored in the containers operate in independent and asynchronous manner.

The interception system of the invention further comprises a first module for storing the content of documents intercepted by the module for intercepting and processing packets, and a second module for storing information relating to at least the sender and the destination of intercepted documents.

Advantageously, the interception system further comprises a module for storing information relating to the components that result from detecting the content of intercepted documents.

According to another aspect of the invention, the interception system further comprises a centralized system comprising means for producing fingerprints of sensitive documents under surveillance, means for producing fingerprints of intercepted documents, means for storing fingerprints produced from sensitive documents under surveillance, means for storing fingerprints produced from intercepted documents, means for comparing fingerprints coming from the means for storing fingerprints produced from intercepted documents with fingerprints coming from the means for storing fingerprints produced from sensitive documents under surveillance, and means for processing alerts, containing the references of intercepted documents that correspond to sensitive documents.

Under such circumstances, the interception system may include selector means responding to the means for processing alerts to block intercepted documents or to forward them towards a second network B, depending on the results delivered by the means for processing alerts.

In an advantageous application, the centralized system further comprises means for associating rights with each sensitive document under surveillance, and means for storing information relating to said rights, which rights define the conditions under which the document can be used.

The interception system of the invention may also be interposed between a first network of the local area network (LAN) type and a second network of the LAN type, or between a first network of the Internet type and a second network of the Internet type.

The interception system of the invention may be interposed between a first network of the LAN type and a second network of the Internet type, or between a first network of the Internet type and a second network of the LAN type.

The system of the invention may include a request generator for generating requests on the basis of sensitive documents that are to be protected, in order to inject requests into the first network.

In a particular embodiment, the request generator comprises:
means for producing requests from sensitive documents under surveillance;
means for storing the requests produced;
means for mining the first network A with the help of at least one search engine using the previously stored requests;
means for storing the references of suspect files coming from the first network A; and
means for sweeping up suspect files referenced in the means for storing references and for sweeping up files from the neighborhood, if any, of the suspect files.

In a particular application, said means for comparing fingerprints deliver a list of retained suspect documents having a degree of pertinence relative to sensitive documents, and the alert processor means deliver the references of an intercepted document when the degree of pertinence of said document is greater than a predetermined threshold.

The interception system may further comprise, between said means for comparing fingerprints and said means for processing alerts, a module for calculating the similarity between documents, which module comprises:

a) means for producing an interference wave representing the result of pairing between a concept vector taken in a given order defining the fingerprint of a sensitive document and a concept vector taken in a given order defining the fingerprint of a suspect intercepted document; and

b) means for producing an interference vector from said interference wave enabling a resemblance score to be determined between the sensitive document and the suspect intercepted document under consideration, the means for processing alerts delivering the references of a suspect intercepted document when the value of the resemblance score for said document is greater than a predetermined threshold.

Alternatively, the interception system further comprises, between said means for comparing fingerprints and said means for processing alerts, a module for calculating similarity between documents, which module comprises means for producing a correlation vector representative of the degree of correlation between a concept vector taken in a given order defining the fingerprint of a sensitive document and a concept vector taken in a given order defining the fingerprint of a suspect intercepted document, the correlation vector enabling a resemblance score to be determined between the sensitive document and the suspect intercepted document under consideration, the means for processing alerts delivering the references of a suspect intercepted document when the value of the resemblance score for said document is greater than a predetermined threshold.

Other characteristics and advantages of the invention appear from the following description of particular embodiments, made with reference to the accompanying drawings, in which:

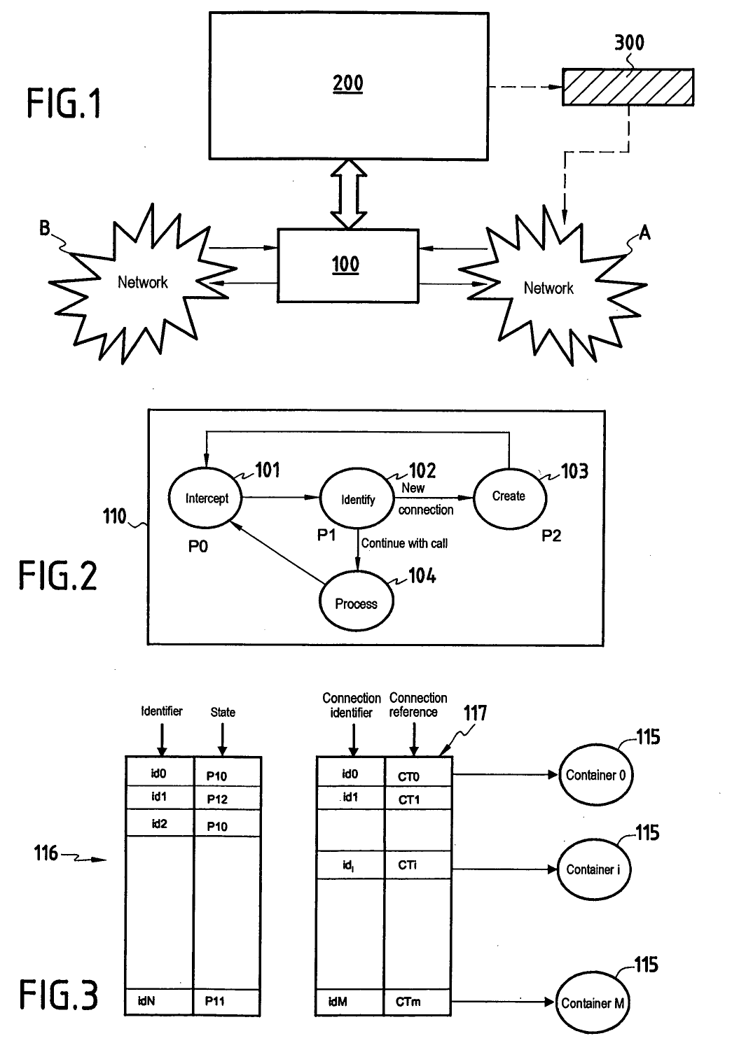

FIG. 1 is a block diagram showing the general principle on which a multimedia document interception system of the invention is constituted;

FIGS. 2 and 3 are diagrammatic views showing the process implemented by the invention to intercept and process packets while intercepting multimedia documents;

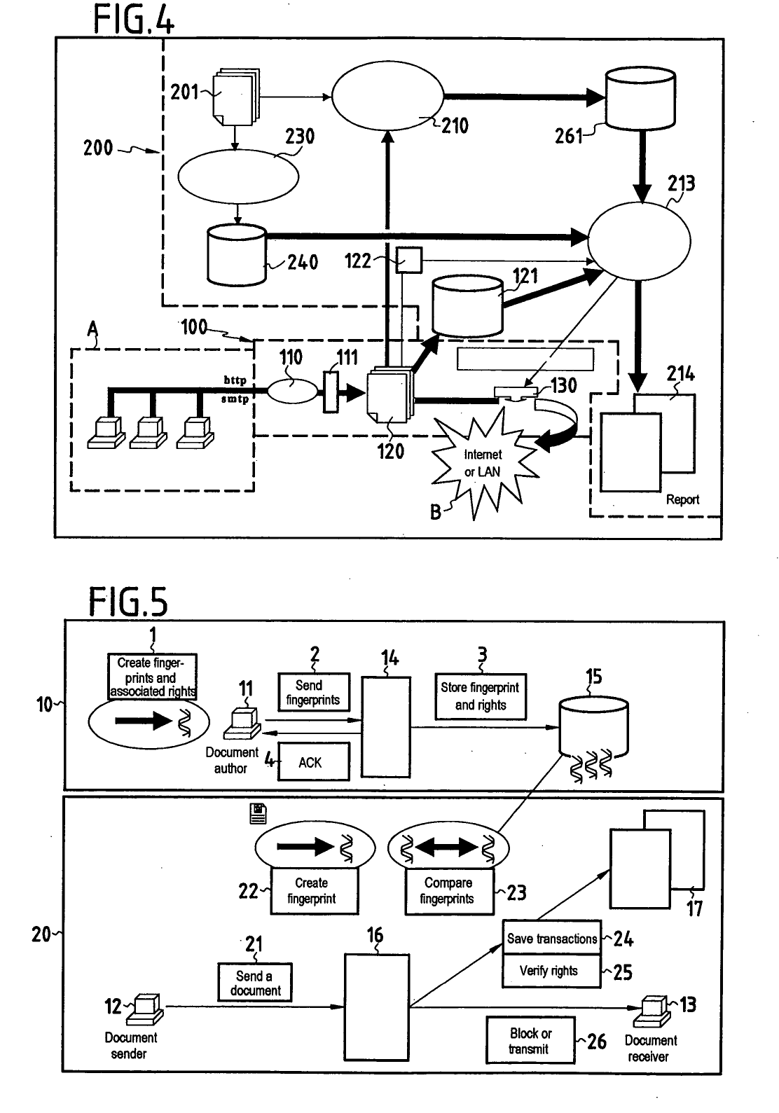

FIG. 4 is a block diagram showing various modules of an example of a global system for intercepting multimedia documents in accordance with the invention;

FIG. 5 shows the various steps in a process of confining sensitive documents that can be implemented by the invention;

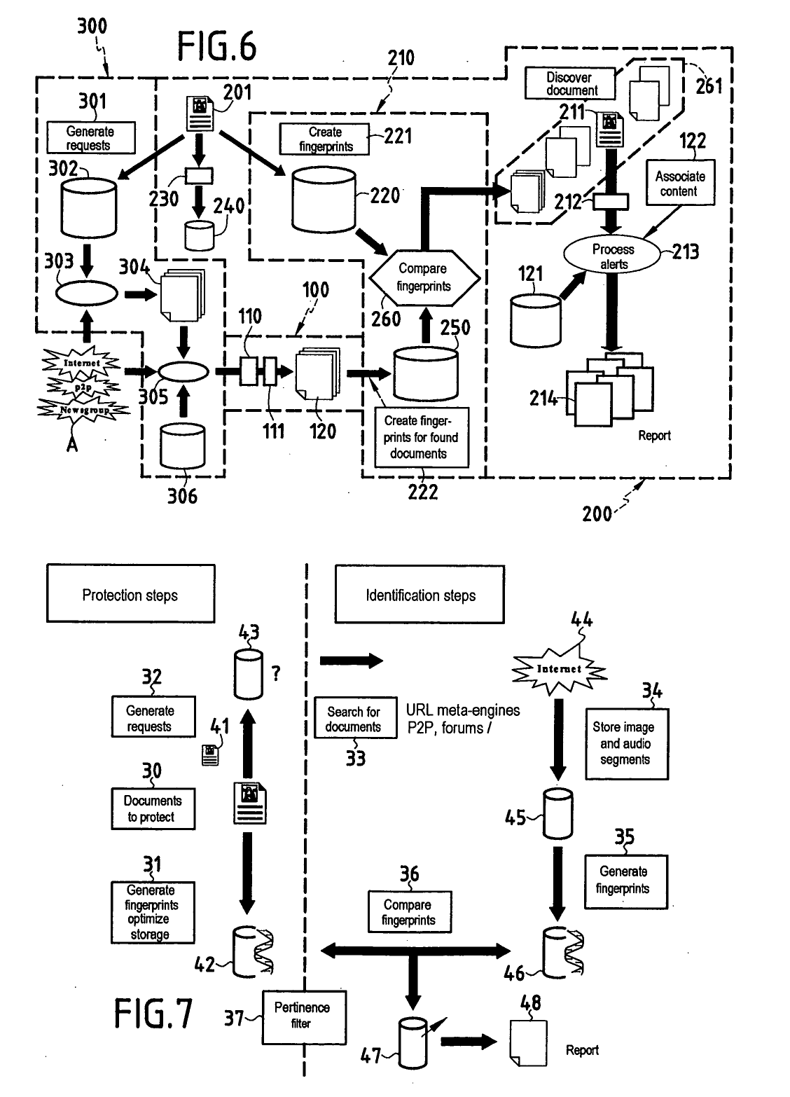

FIG. 6 is a block diagram of an example of an interception system of the invention showing how alerts are treated and how reports are generated in the event of requests being generated to interrogate suspect sites and to detect suspect documents;

FIG. 7 is a diagram showing the various steps of an interception process as implemented by the system of FIG. 6;

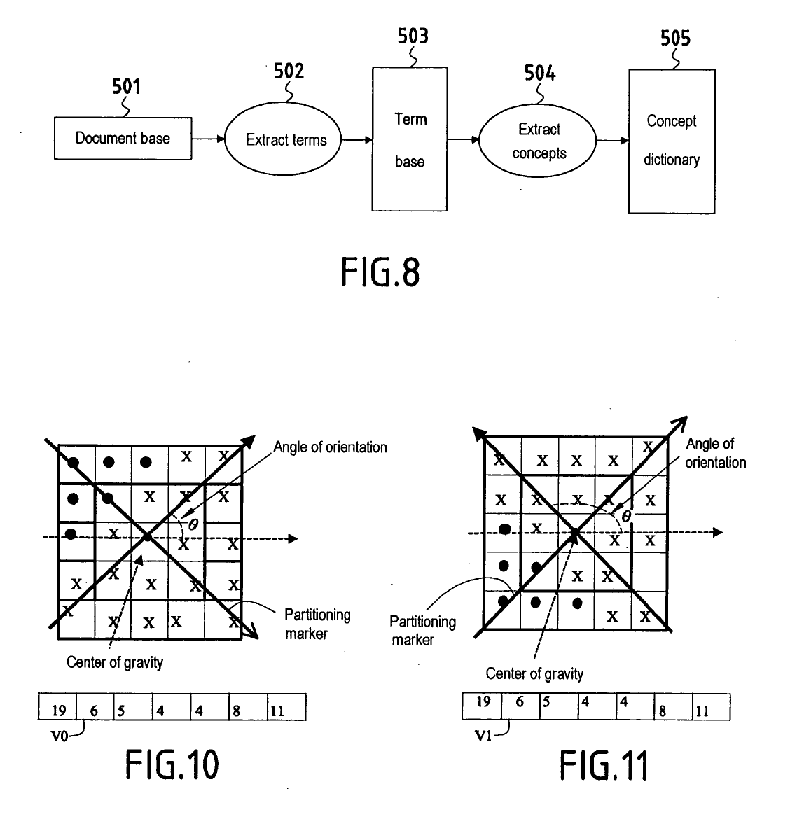

FIG. 8 is a block diagram showing the process of producing a concept dictionary from a document base;

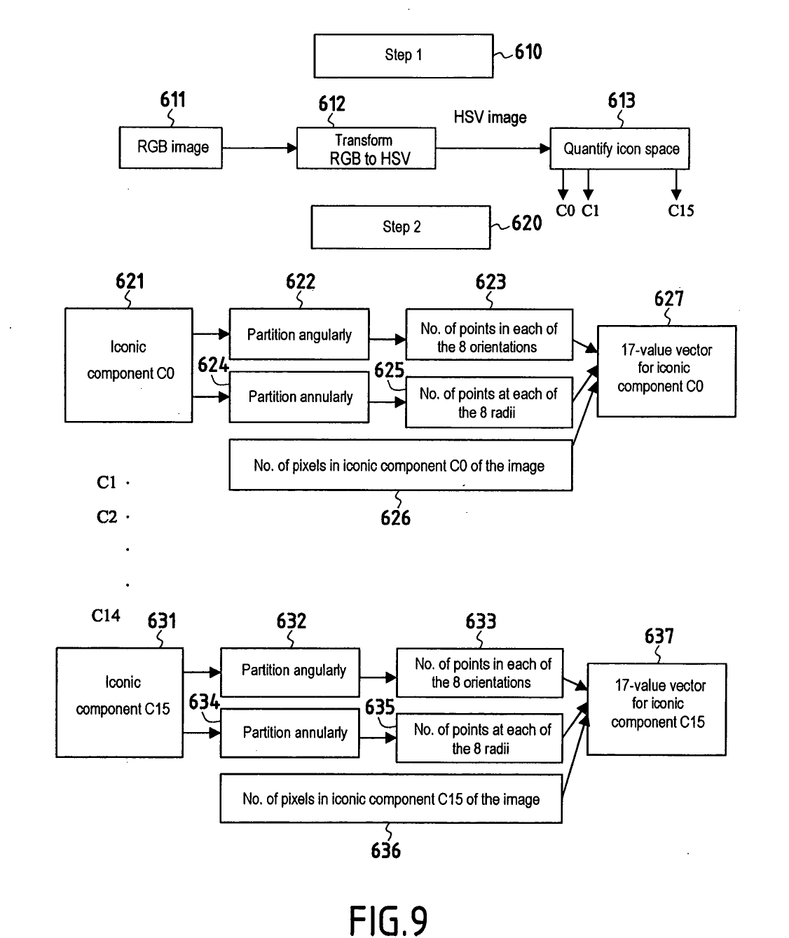

FIG. 9 is a flow chart showing the various steps of processing and partitioning an image with vectors being established that characterize the spatial distribution of iconic components of an image;

FIG. 10 shows an example of image partitioning and of a characteristic vector for said image being created;

FIG. 11 shows the partitioned image of FIG. 10 turned through 90°, and shows the creation of a characteristic vector for said image;

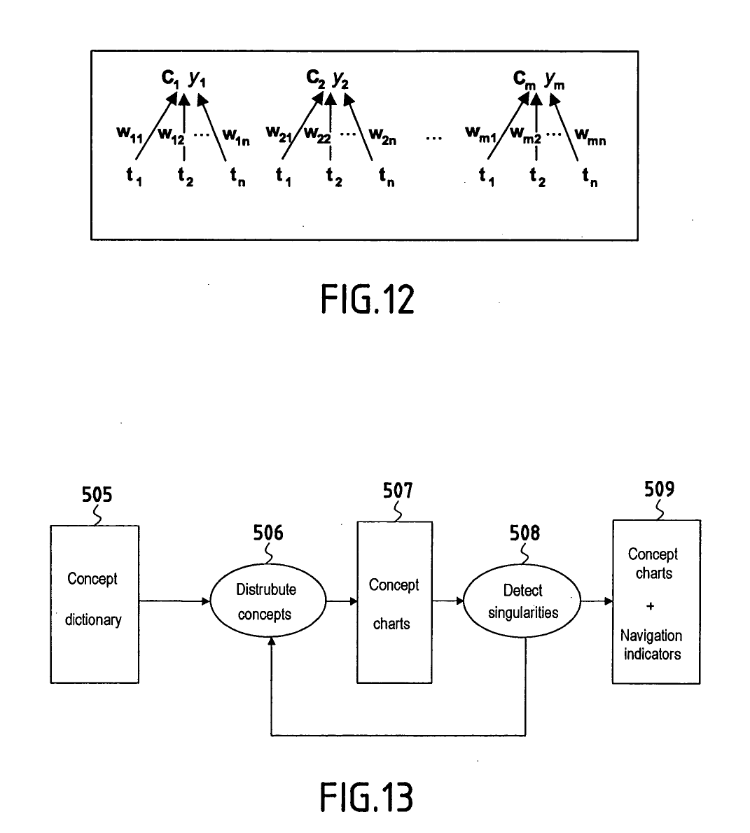

FIG. 12 shows the principle on which a concept base is built up from terms;

FIG. 13 is a block diagram showing the process whereby a concept dictionary is structured;

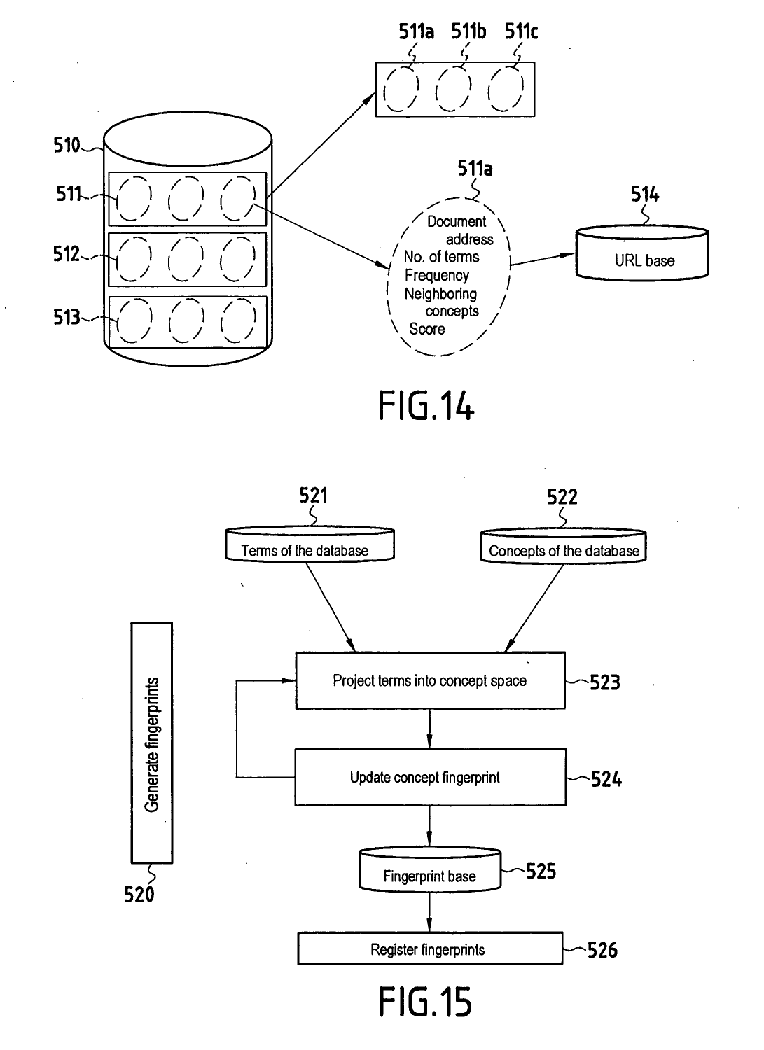

FIG. 14 shows the structuring of a fingerprint base;

FIG. 15 is a flow chart showing the various steps in the building of a fingerprint base;

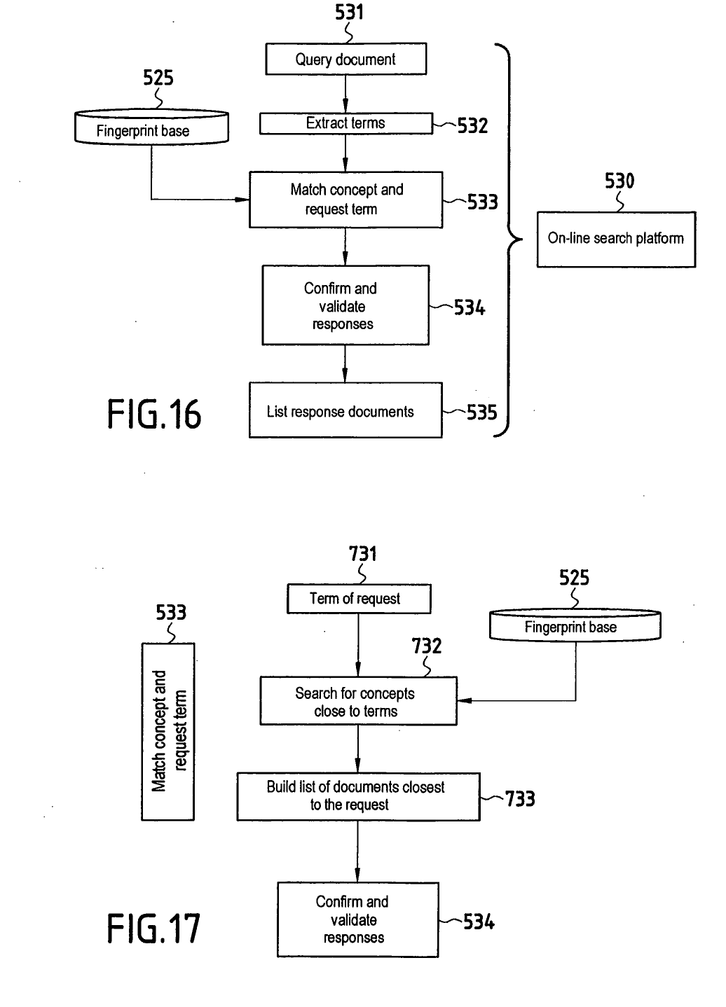

FIG. 16 is a flow chart showing the various steps in identifying documents;

FIG. 17 is a flow chart showing the selection of a first list of responses;

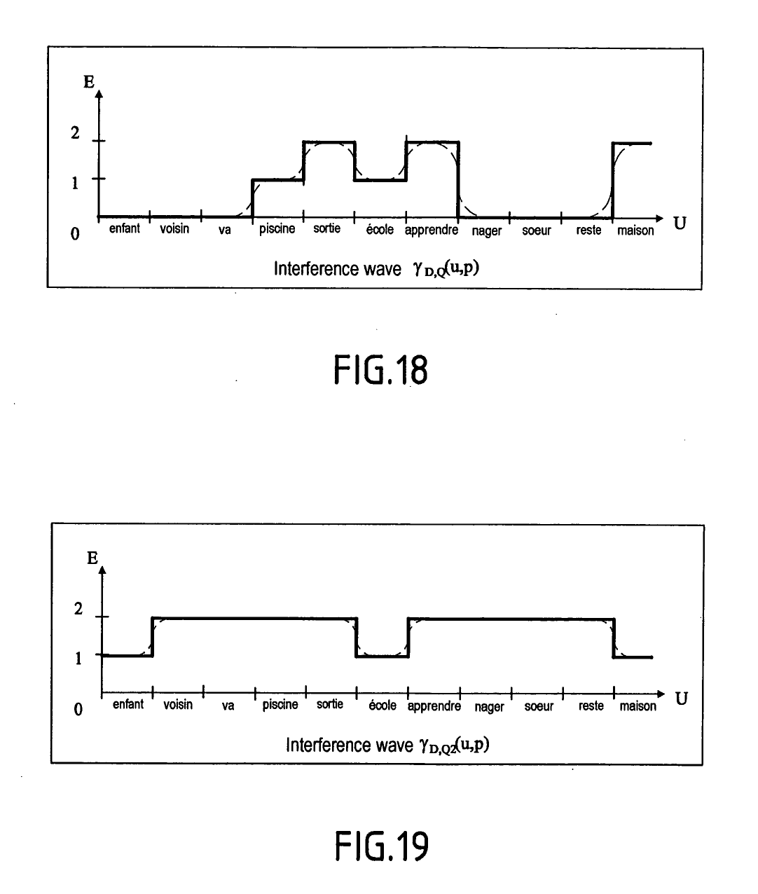

FIGS. 18 and 19 show two examples of interference waves; and

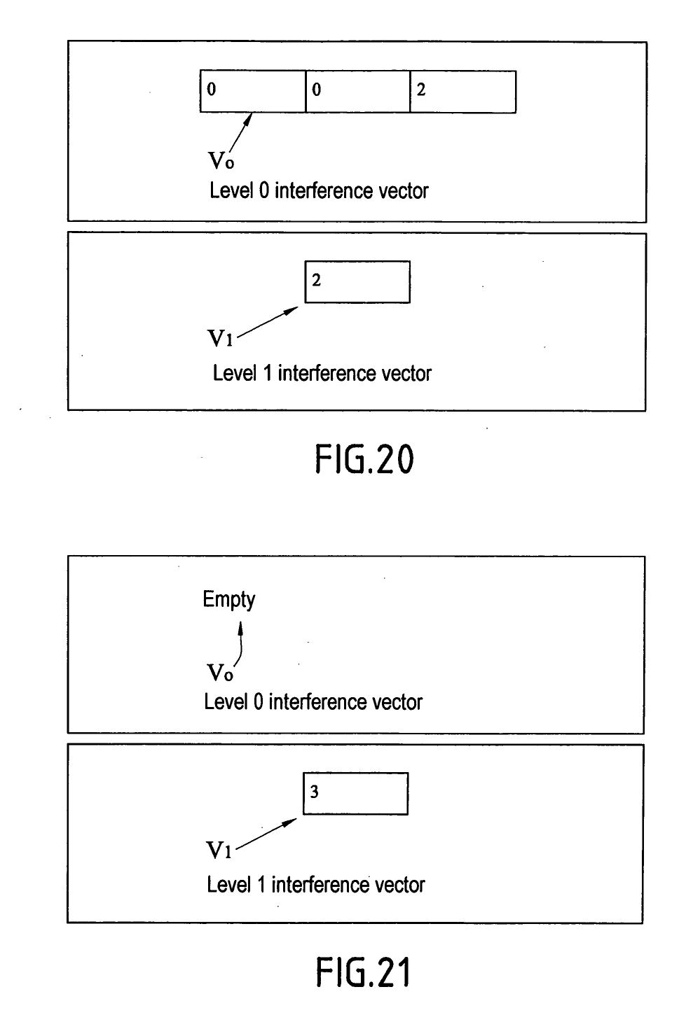

FIGS. 20 and 21 show two examples of interference vectors corresponding respectively to the interference wave examples of FIGS. 18 and 19.

The system for intercepting multimedia documents disseminated from a first network A comprises a main module 100 itself comprising a module 110 for intercepting and processing information packets each including an identification header and a data body. The module 110 for intercepting and processing information is thus a low level module, and it is itself associated with means 111 for analyzing data content, for recognizing protocols, and for reconstituting intercepted documents (see FIGS. 1, 4, and 6).

The means 111 supply information relating to the intercepted documents firstly to a module 120 for storing the content of intercepted documents, and secondly to a module 121 for storing information containing at least the sender and the destination of intercepted documents (see FIGS. 4 and 6).

The main module 100 co-operates with a centralized system 200 for producing alerts containing the references of intercepted documents that correspond to previously identified sensitive documents.

Following intervention by the centralized system 200, the main module 100 can, where appropriate and by using means 130, selectively block the transmission towards a second network B of intercepted documents that are identified as corresponding to sensitive documents (FIG. 4).

A request generator 300 serves, where appropriate, to mine the first network A on the basis of requests produced from sensitive documents to be monitored, in order to identify suspect files coming from the first network A (FIGS. 1 and 6).

Thus, in an interception system of the invention, there are to be found in a main module 100 activities of intercepting and blocking network protocols both at a low level and then at a high level with a function of interpreting content. The main module 100 is situated in a position between the networks A and B that enables it to perform active or passive interception with an optional blocking function, depending on configurations and on co-operation with networks of the LAN type or of the Internet type.

The centralized system 200 groups together various functions that are described in detail below, concerning rights management, calculating document fingerprints, comparison, and decision making.

The request generator 300 is optional in certain applications and may in particular include generating peer-to-peer (P2P) requests.

Various examples of applications of the interception system of the invention are mentioned below:

The network A may be constituted by an Internet type network on which mining is being performed, e.g. of the active P2P or HTML type, while the documents are received on a LAN network B.

The network A may also be constituted by an Internet type network on which passive P2P listening is being performed by the interception system, the information being forwarded over a network B of the same Internet type.

The network A may also be constituted by a LAN type business network on which the interception system can act, where appropriate, to provide total blocking of certain documents identified as corresponding to sensitive documents, with these documents then not being forwarded to an external network B of the Internet type.

The first and second networks A and B may also both be constituted by LAN type networks that might belong to the same business, with the interception system serving to provide selective blocking of documents between portion A of the business network and portion B of said network.

The invention can be implemented with an entire set of standard protocols, such as in particular: HTTP; SMPT, FTP, POP, IMPA; TELNET; P2P.

The operation of P2P protocols is recalled below by way of example.

P2P exchanges are performed by means of computers known as “nodes” that share content and content descriptions with their neighbors.

A P2P exchange is often performed as follows:
a request is issued by a node U;
this request is forwarded from neighbor to neighbor within the structure, while applying the rules of each specific P2P protocol;
when a node D is capable of responding to the request r, it sends a response message R to the issuing node U. This message contains information relating to loading content C. The message R frequently follows a path similar to that over which the request came;
when various responses R have reached the node U, it (or the user in general) decides which response R to accept and it thus requests direct loading (peer-to-peer) of the content C described in the response R from the node D to the node U where it is located.

Requests and responses R are provided with identification that makes it possible to determine which responses R correspond to a given request r.

The main module 100 of the interception system of the invention, which contains the elements for intercepting and blocking various protocols is situated on the network either in the place of a P2P network node, or else between two nodes.

The basic operation of the P2P mechanism for passive and active interception and blocking is described below.

Passive P2P interception consists in observing the requests and the responses passing through the module 100, and using said identification to restore proper pairing.

Passive P2P blocking consists in observing the requests that pass through the module 100 and then in blocking the responses in a buffer memory 120, 121 in order to sort them. The sorting consists in using the responses to start file downloading towards the common system 200 and to request it to compare the file (or a portion of the file) by fingerprint extraction with the database of documents to be protected. If the comparison is positive and indicates that the downloaded file corresponds to a protected document, the dissemination authorizations for the protected document are consulted and a decision is taken instructing the module 100 to retransmit the response from its buffer memory 120, 121, or to delete it, or indeed to replace it with a “corrected” response: a response message carrying the identification of the request is issued containing downloading information pointing towards a “friendly” P2P server (e.g. a commercial server).

Active P2P interception consists in injecting requests from one side of the network A and then in observing them selectively by means of passive listening.

Active P2P blocking consists in injecting requests from one side of the network A and then in processing the responses to said request suing the above-described method used in passive interception.

To improve the performance of the passive listening mechanism, and starting from the interception position as constituted by the module 100, it is possible to act in various ways:
to modify the requests that are observed in transit, e.g. by increasing the scope of their searching, the networks concerned, correcting spelling mistakes, etc.; and/or
generating copy requests for duplicating the effectiveness of the search, either by reissuing full copies that are offset in time in order to prolong the search, or by issuing modified copies of said requests in order to increase the diversity of responses (variant spellings, domains, networks).

The system of the invention enables businesses in particular to control the dissemination of their own documents and to stop confidential information leaking to the outside. It also makes it possible to identify pertinent data that is present equally well inside and outside the business. The data may be documents for internal use or even data that is going to be disseminated but which is to be broadcast in compliance with user rights (author's rights, copyright, moral rights, . . . ). The pertinent information may also relate to the external environment: information about competition, clients, rumors about a product, or an event.

The invention combines several approaches going from characterizing atoms of content to characterizing the disseminated media and support. Several modules act together in order to carry out this process of content traceability. Within the centralized system 200, a module serves to create a unique digital fingerprint characterizing the content of the work and enabling it to be identified and to keep track of it: it is a kind of DNA test that makes it possible, starting from anonymous content, to find the indexed original work and thus verify the associated legal information (authors, successors in title, conditions of use, . . . ) and the conditions of use that are authorized. The main module 100 serves to automate and specialize the scanning and identification of content on a variety of dissemination media (web, invisible web, forums, news groups, peer-to-peer, chat) when searching for sensitive information.

It also makes it possible to intercept, analyze, and extract contents disseminated between two entities of a business or between the business and the outside world. The centralized system 200 includes a module making use of content mining techniques and it extracts pertinent information from large volumes of raw data, and then stores the information in order to make effective use of it.

Before returning in greater detail to the general architecture of the interception system of the invention, there follows a description with reference to FIGS. 2 and 3 of the module 100 for intercepting and processing information packets, each including an identification header and a data body.

It is recalled that in the world of the Internet, all exchanges take place by sending and receiving packets. These packets are made up of two portions: a header and a body (data). The header contains information describing the content transported by the packet such as the type, the number and the length of the packet, the address of the sender and the destination address. The body of the packet contains the data proper. The body of a packet may be empty.

Packets can be classified in two classes: those that serve to ensure proper operation of the network (knowing the state of a unit in the network, knowing the address of a machine, setting up a connection between two machines, . . . ), and those that serve to transfer data between applications (sending and receiving email, files, pages, . . . ).

Sending a document can require a plurality of packets to be sent over the network. These packets can be interlaced with packets coming from other senders. A packet can transit through a plurality of machines before reaching its destination. Packets can follow different paths and arrive in the wrong order (a packet sent at instant t+1 can arrive sooner than the packet that was sent at instant t).

Data transfer can be performed either in connected mode or in non-connected mode. In connected mode (http, smtp, telenet, ftp, . . . ) which relies on the TCP protocol, data transfer is preceded by a synchronization mechanism (setting up the connection). A TCP connection is set up in three stages (three packets):

1) the caller (referred to as the “client”) sends SYN (a packet in which the flag SYN is set in the header of the packet);

2) the receiver (referred to as the “server”) responds with SYN and ACK (a packet in which both the SYN and the ACK flags are set); and

3) the caller sends ACK (a packet in which the ACK flag is set).

The client and the server are both identified by their respective MAC, IP addresses and by the port number of the service in question. It is assumed that the client (sender of the first packet in which the bit SYN is set) knows the pair (IP address of receiver, port number of desired service). Otherwise, the client begins by requesting the IP address of the receiver.

The role of the document interception module 110 is to identify and group together packets transporting data within a given application (http, SMTP, telnet, ftp, . . . ).

In order to perform this task, the interception module analyzes the packets of the IP layers, of the TCP/UDP transport layers, and of the application layers (http, SMPT, telnet, ftp, . . . ). This analysis is performed in several steps:
identifying, intercepting, and concatenating packets containing portions of one or more documents exchanged during a call, also referred to as a “connection” when the call is one based on the TCP protocol. A connection is defined by the IP addresses and the port numbers of the client and of the server, and possibly also by the Mac address of the client and of the server; and
extracting data encapsulated in the packets that have just been concatenated.

As shown in FIG. 2, intercepting and fusing packets can be modeled by a 4-state automaton:

P0: state for intercepting packets disseminated from a first network A (module 101).

P1: state for identifying the intercepted packet from its header (module 102). Depending on the nature of the packet, it activates state P2 (module 103) if the packet is sent by the client for a connection request. It invokes P3 (module 104) if the packet forms part of a call that has already been set up.

P2: state P2 (module 103) serves to create a unique identifier for characterizing the connection, and it also creates a storage container 115 containing the resources needed for storing and managing the data produced by the state P3. It associates each connection with a triplet <identifier, connection state flag, storage container>.

P3: state P3 (module 104) serves to process the packets associated with each call. To do this, it determines the identifier of the received packet in order to access the storage container 115 where it saves the data present in the packet.

As shown in FIG. 3, the procedure for identifying and fusing packets makes use of two tables 116 and 117: a connection setup table 116 contains the connections that are being set up, and a container identification table 117 contains the references of the containers of connections that have already been set up.

The identification procedure examines the header of the frame and on each detection of a new connection (the SYN bit set on its own) it creates an entry in the connection setup table 116 where it stores the pair comprising the connection identifier and the connectionState flag giving the state of the connection <connectionId, connectionState>. The connectionState flag can take three possible values (P10, P11, and P12):

connectionState is set at P10 on detecting a connection request;

connectionState is set at P11 if connectionState is equal to P10 and the header of the frame corresponds to a response from the server. The two bits ACK and SYN are set simultaneously;

connectionState is set at P12 if connectionState is equal to P11 and the header of the frame corresponds to confirmation from the client. Only ACK is set.

When the connectionState flag of a connectionId is set to P12, that implies deletion of the entry corresponding to this connectionId from the connection setup table 116 and the creation in the container identification table 117 of an entry containing the pair <connectionId, containerRef> in which containerRef designates the reference of the container 115 dedicated to storing the data extracted from the frames of the connection connectionId.

The purpose of the treatment step is to recover and store in the containers 115 the data that is exchanged between the senders and the receivers.

While receiving a frame, the identifier of the connection connectionId is determined, thus making it possible using containerRef to locate the container 115 for storing the data of the frame.

At the end of a connection, the content of its container is analyzed, the various documents that make it up are stored in the module 120 for storing the content of intercepted documents, and the information concerning destinations is stored in the module 121 for storing information concerning at least the sender and the destination of the intercepted documents.

The module 111 for analyzing the content of the data stored in the containers 125 serves to recognize the protocol in use from a set of standard protocols such as, in particular: http, SMTP, ftp, POP, IMAP, TELNET, P2P, and to reconstitute the intercepted documents.

It should be observed that the packet interception module 101, the packet header analysis module 102, the module 103 for creating an automaton, the packet processing module 104, and the module 111 for analyzing the content of data stored in the containers 115 all operate in independent and asynchronous manner.

Thus, the document interception module 110 is an application of the network layer that intercepts the frames of the transport layer (transmission control protocol (TCP) and user datagram protocol (UDP)) and Internet protocol packets (IP) and, as a function of the application being monitored, that processes them and fuses them to reconstitute content that has transmitted over the network.

With its centralized system 200, the interception system of the invention can lead to a plurality of applications all relating to the traceability of the digital content of multimedia documents.

Thus, the invention can be used for identifying illicit dissemination on Internet media (Net, P2P, news group, . . . ) or on LAN media (sites and publications within a business), or to identify and stop any attempt at illicit dissemination (not complying with the confinement perimeter of a document) from one machine to another, or indeed to ensure that the operations (publication, modification, editing, printing, etc.) performed on documents in a collaborative system (a data processor system for a group of users) are authorized, i.e. comply with rules set up by the business. For example it can prevent a document being published under a heading where one of the members does not have document consultation rights.

The system of the invention has a common technological core based on producing and comparing fingerprints and on generating alerts. The applications differ firstly in the origins of the documents received as input, and secondly in the way in which alerts generated on identifying an illicit document are handled. While processing alerts, reports may be produced that describe the illicit uses of the documents that have given rise to the alerts, or the illicit dissemination of the documents can be blocked. The publication of a document in a work group can also be prevented if any of the members of that group are not authorized to use (read, write, print, . . . ) the document.

With reference to FIG. 6, it can be seen that the centralized system 200 comprises a module 221 for producing fingerprints of sensitive documents under surveillance 201, a module 222 for producing fingerprints of intercepted documents, a module 220 for storing the fingerprints produced from the sensitive documents under surveillance 201, a module 250 for storing the fingerprints produced from the intercepted documents, a module 260 for comparing the fingerprints coming from the storage modules 250 and 220, and a module 213 for processing alerts containing the references of intercepted documents 211 that correspond to sensitive documents.

A module 230 enables each sensitive document under surveillance 201 to be associated with rights defining the conditions under which the document can be used and a module 240 for storing information relating to said rights.

Furthermore, a request generator 300 may comprise a module 301 for producing requests from sensitive documents under surveillance 201, a module 302 for storing the requests produced, a module 303 for mining the network A using one or more search engines making use of previously stored requests, a module 304 for storing references of suspect files coming from the network A, and a module 305 for sweeping up suspect files referenced in the reference storage module 304. It is also possible in the module 305 to sweep up files from the neighborhood of files that are suspect or to sweep up a series of predetermined sites whose references are stored in a reference storage module 306.

In the invention, it is thus possible to proceed with automated mining of a network in order to detect works that are protected by copyright, by providing a regular summary of works found on Internet and LAN sites, P2P networks, news groups, and forums. The traceability of works is ensured on the basis of their originals, without any prior marking.

Reports 214 sent at a selected frequency provide pertinent information and documents useful for accumulating data on the (licit or illicit) ways in which referenced works are used. A targeted search and reliable automatic recognition of works on the basis of their content ensure that the results are of high quality.

FIG. 7 summarizes, for web sites, the process of protecting and identifying a document. The process is made up of two stages:

Protection Stage

This stage is performed in two steps:

Step 31: generating the fingerprint of each document to be protected 30, associating the fingerprint with user rights (description of the document, proprietor, read, write, period, . . . ) and storing said information in a database 42.

Step 32: generating requests 41 that are used to identify suspect sites and that are stored in a database 43.

Identification Stage

Step 33: sweeping up and breaking down pages from sites:
Making use of the requests generated in step 32 to recover from the network 44 the addresses of sites that might contain data that is protected by the system. The information relating to the identified sites is stored in a suspect-site base.
Sweeping up and breaking down the pages of the sites referenced in the suspect-site base and in a base that is fed by users and that contains the references of sites having content that is it is desired to monitor (step 34). The results are stored in the suspect-content base 45 which is made up of a plurality of sub-databases, each having some particular type of content.

Step 35: generating the fingerprints of the content of the database 45.

Step 36: comparing these fingerprints with the fingerprints in the database 42 and generating alerts that are stored in a database 47.

Step 37: processing the alerts and producing reports 48. The processing of alerts makes use of the content-association base to generate the report. It contains relationships between the various components of the system (queries, content, content addresses (site, page address, local address, . . . ), the search engine that identified the page, . . . ).

The interception system of the invention can also be integrated in an application that makes it possible to implement an embargo process mimicking the use of a “restricted” stamp that validates the authorization to distribute documents within a restricted group of specific users from a larger set of users that exchange information, where this restriction can be removed as from a certain event, where necessary.

Under such circumstances, the embargo is automatic and applies to all of the documents handled within the larger ensemble that constitutes a collaborative system. The system discovers for any document Y waiting to be published whether it is, or contains a portion of, a document Z that has already been published, and whether the rights associated with that publication of Z are compatible with the rights that are to be associated with Y.

Such an embargo process is described below.

When a user desires to publish a document, the system must initially determine whether the document contains or all part of a document that has already been published, and if so, it must determine the corresponding rights.

The process thus implements the following steps:

Step 1: generating a fingerprint E for the document C, associating said fingerprint with the date D of the request and the user U that made the request, and also the precise nature N of the request (email, general publication, memo, etc. . . . ).

Step 2: comparing said fingerprint E with those already present in a database AINBase which contains the fingerprint of each document that has already been registered, together with the following information:
the publishing user: U2;
the rights associated with said publication (e.g. the work group to which the document belongs, the work groups that have read rights, the work groups that have modification rights, etc.): G; and
the limiting validity date of the stamp: DV.

Step 3: IF the fingerprint E is similar to a fingerprint F already present in the database AINBase, the rights associated with F are compared with the information collected in step 1. Two situations can then arise:

IF (D<=DV) AND (U does not belong to G) THEN the rights and the user status are not compatible, and if the publication date is earlier than the limiting validity date, the system will reject the request:

the fingerprint E is not inserted in AINBase;

the document C is not inserted in the document base of the collaborative system; and

an exception X is triggered.

ELSE:

the rights and the user status are compatible, so the document is accepted. If no rights have already been associated with the content, then the publishing user becomes the reference user of the document. That user can set up a specific embargo system:

1) the fingerprint E is inserted in AINBase;

2) the document C is inserted in the document base of the collaborative system;

date comparison can enable the embargo to be ended automatically as soon as the date exceeds the limiting date of the initially-defined embargo, thus having the effect of eliminating the corresponding constraints on publishing, modifying, etc. the document.

FIG. 4 summarizes an interception system of the invention that enables any attempt at disseminating documents to be stopped if it does not comply with the usage rights of the documents.

In this example, dissemination that is not in compliance may correspond either to sending out a document that is not authorized to leave its confinement unit, or to sending a document to a person who is not authorized to receive it, or to receiving a document that presents a special characteristic, e.g. it is protected by copyright.

The interception system of the invention comprises a main module 100 serving to monitor the content interchanged between two pieces of network A and B (Internet or LAN). To do this, incoming and outgoing packets are intercepted and put into correspondence in order to determine the nature of the call, and in order to reconstitute the content of documents exchanged during a call. Putting frames into correspondence makes it possible to determine the machine that initiated the call, to determine the protocol that is in use, and to associate each intercepted content with its purpose (its sender, its addressees, the nature of the operation: “get”, “post”, “put”, “send”, . . . ). The sender and the addressees may be people, machines, or any type of reference enabling content to be located. The purposes that are processed include:

1) sending email from a sender to one or more addressees;

2) requesting downloading of a web page or a file;

3) sending a file or a web page using protocols of the http, ftp, or p2p type, for example.

When intercepting an intention to send or download a web page or a file, the intention in question is stored pending interception of the page or file in question and is then processed. If the intercepted content contains sensitive documents, then an alert is produced containing all of the useful information (the parties, the references of the protected documents), thus enabling the alert processor system to take various different actions:

1) trace content and supervise procedures for accessing the content;

2) produce reports on the exchanges (statistics, etc.); and/or

3) where necessary block transmission associated with intentions that are not in compliance.

The interception system for monitoring the content of documents disseminated by the network A and for preventing dissemination or transmission to destinations or groups of destinations that are not authorized to receive the sensitive document essentially comprises a main module 100 with an interception module 110 serving to recover and break down the content transiting therethrough or present on the disseminating network A. The content is analyzed in order to extract therefrom documents constituting the intercepted content. The results are stored in:
the storage module 120 that stores the documents extracted from the intercepted content;
the storage module 121 containing the associations between the extracted documents, the intercepted contents, and intentions: the destinations of the intercepted contents; and where appropriate
the storage module 122 containing information relating to the components obtained by breaking down the intercepted documents.

A module 210 serves to produce alarms indicating that intercepted content contains a portion of one or more sensitive documents. This module 210 is essentially composed of two modules:
the module 221, 222 for producing fingerprints of sensitive documents and of intercepted documents (see FIG. 6); and
the module 260 for comparing the fingerprints of intercepted documents with the fingerprints in the sensitive document base and for producing alerts containing the references of sensitive documents to be found amongst the intercepted documents. The results output from the module 250 are stored in a database 261.

A module 230 enables each document to be associated with rights defining the conditions under which the document can be used. The results from the module 230 are stored in the database 240.

The module 213 serves to process alerts and to produce reports 214. Depending on the policy adopted, the module 213 can block movement of the document containing sensitive elements by means of the blocking module 130, or it can forward the module to a network B.

An alert is made up of the reference, in the storage module 120, of the content of the intercepted document that has given rise to the alert, together with the references of the sensitive documents that are the source of the alert. From these references and from the information registered in the databases 240 and 121, the module 213 decides whether or not to follow up the alert. The alert is taken into account if the destination of the content is not declared in the database 240 as being amongst the users of the sensitive document that is the source of the alert.

When an alert is taken into account, the content is not transmitted and a report 214 is produced that explains why it was blocked. The report is archived, an account is delivered in real time to the people in charge, and depending on the policy that has been adopted, the sender might be warned by an email, for example. The content of the storage module 120 that did not give rise to an alert or whose alarms have been ignored is put back into circulation by the module 130.

FIG. 5 summarizes the operation of the process for intercepting and blocking sensitive documents within operating perimeters defined by the business. This process comprises a first portion 10 corresponding to registration for confinement purposes and a second portion 20 corresponding to interception and to blocking.

The process of registration for confinement comprises a step 1 of creating fingerprints and associated rights, and identifying the confinement perimeter (proprietors, user groups). In the station 11 where the document is created, a step 2 consists in sending fingerprints to an agent server 14, and then a step 3 lies in storing the fingerprints and the rights in a fingerprint base 15. A step 4 consists in the agent server 14 sending an acknowledgment of receipt to the workstation 11.

The interception and blocking process optionally comprises the following steps:

Step 21: sending a document from a document-sending station 12. An interception step in the interception module 16 where a document leaving a region of network under surveillance is intercepted.

Step 22: creating a fingerprint for the recovered document.

Step 23: comparing fingerprints in association with the database 15 and the interception module 16 to generate alerts indicating the presence of a sensitive document in the intercepted content.

Step 24: saving transactions in a database 17.

Step 25: verifying rights.

Step 26: blocking or transmitting to a document-receiver station 13 depending on whether the intercepted document is or is not allowed to leave the confinement perimeter.

With reference to FIGS. 8 and 12 to 15, there follows a description of the general principle of a method of the invention for indexing multimedia documents that leads to a fingerprint base being built, each indexed document being associated with a fingerprint that is specific thereto.

Starting from a multimedia document base 501, a first step 502 consists in identifying and extracting, for each document, terms tᵢ constituted by vectors characterizing the properties of the document that is to be indexed.

By way of example, it is possible to identify and extract terms tᵢ from a sound document.

An audio document is initially decomposed into frames which are subsequently grouped together into clips, each of which is characterized by a term constituted by a parameter vector. An audio document is thus characterized by a set of terms tᵢ stored in a term base 503 (FIG. 8).

Audio documents from which the characteristic vectors have been extracted can be sampled at 22,050 hertz (Hz) for example in order to avoid the aliasing effect. The document is then subdivided into a set of frames with the number of samples per frame being set as a function of the type of file to be analyzed.

For an audio document that is rich in frequencies and that contains many variations, as for films, variety shows, or indeed sports broadcasts, for example, the number of samples in a frame should be small, e.g. of the order 512 samples. In contrast, for an audio document that is homogeneous, containing only speech or only music, for example, this number can be large, e.g. about 2,048 samples.

An audio document clip may be characterized by various parameters serving to constitute the terms and characterizing time information (such as energy or oscillation rate, for example) or frequency information (such as bandwidth, for example).

Consideration is given above to multimedia documents having audio components.

When indexing multimedia documents that include video signals, it is possible to select terms tᵢ constituted by key-images representing groups of consecutive homogeneous images.

The terms tᵢ can in turn represent, for example: dominant colors, textural properties, or the structures of dominant zones in the key-images of the video document.

In general, for images as described in greater detail below, the terms may represent dominant colors, textural properties, and/or the structures of dominant zones of the image. Several methods can be implemented in alternation or cumulatively, both over an entire image or over portions of the image, in order to determine the terms tᵢ that are to characterize the image.

For a document containing text, the terms tᵢ can be constituted by words in spoken or written language, by numbers, or by other identifiers constituted by combinations of characters (e.g. combinations of letters and digits).

With reference again to FIG. 8; starting from a term base 503 having P terms, the terms tᵢ are processed in a step 504 and grouped together into concepts cᵢ (FIG. 12) for storing in a concept dictionary 505. The idea at this point is to generate a step of signatures characterizing a class of documents. The signatures are descriptors which, e.g. for an image, represent color, shape, and texture. A document can then be characterized and represented by the concepts of the dictionary.

A fingerprint of a document can then be formed by the signature vectors of each concept of the dictionary 505. The signature vector is constituted by the documents where the concept cᵢ is present and by the positions and the weight of said concept in the document.

The terms tᵢ extracted from a document base 501 are stored in a term base 503 and processed in a module 504 for extracting concepts cᵢ which are themselves grouped together in a concept dictionary 505. FIG. 12 shows the process of constructing a concept base cᵢ (1≦i≦m) from terms tⱼ (1≦j≦n) presenting similarly scores wiⱼ.

The module for producing the concept dictionary receives as input the set P of terms from the base 503 and the maximum desired number N concepts is set by the user. Each concept cᵢ is intended to group together terms that are neighbors from the point of view of their characteristics.

In order to produce the concept dictionary, the first step is to calculate the distance matrix T between the terms of the base 503, with this matrix being used to create a partition of cardinal number equal to the desired number N of concepts.

The concept dictionary is set up in two stages:
decomposing P into N portions P=P₁ ∪ P₂ . . . ∪ P_{N};
optimizing the partition that decomposes P into M classes P=C₁ ∪ C₂ . . . ∪ C_{M} with M less than or equal to P.

The purpose of the optimization process is to reduce the error in the decomposition of P into N portions {P₁, P₂ . . . , P_{N}} where each portion Pᵢ is represented by the term tᵢ which is taken as being a concept, with the error that is then committed being equal to the following expression:

$$ɛ = {\sum }_{i = 1}^{N} {ɛ}_{{t}_{i}} , \qquad {ɛ}_{{t}_{i}} = {\sum }_{{t}_{j} ∈ {P}_{i}} {d}^{2} ( {t}_{i} , {t}_{j} )$$

is the error committed when replacing the terms tⱼ of Pᵢ by tᵢ.

It is possible to decompose P into N portions in such a manner as to distribute the terms so that the terms that are furthest apart lie in distinct portions while terms that are closer together lie in the same portions.

Step 1 of decomposing the set of terms P into two portions P₁ and P₂ is described initially:

a) the two terms tᵢ and tⱼ in P that are farthest apart are determined, this corresponding to the greatest distance Dᵢⱼ of the matrix T;

b) for each tₖ of P, tₖ is allocated to P₁ if the distance Dₖᵢ is smaller than the distance Dₖⱼ, otherwise it is allocated to P₂.

Step 1 is iterated until the desired number of portions has been obtained. On each iteration, steps a) and b) are applied to the terms of set P₁ and set P₂.

The optimization stage is as follows.

The starting point of the optimization process is the N disjoint portions of P {P₁, P₂, . . . , P_{N}} and the N terms {t₁, t₂, . . . , t_{N}} representing them, and it is used for the purpose of reducing the error in decomposing P into {(P₁, P₂, . . . , P_{N}} portions.

The process begins by calculating the centers of gravity cᵢ of the Pᵢ. Thereafter the error

$$ɛ {c}_{i} = {\sum }_{{t}_{j} ∈ {P}_{i}} {d}^{2} ( {t}_{i} , {t}_{j} )$$

is
calculated that is compared with εcᵢ, and tᵢ is replaced by cᵢ if εcᵢ is less than εtᵢ. Then after calculating the new matrix T and if convergence is not reached, decomposition is performed. The stop condition is defined by:

$$\frac{( ɛ {c}_{t} - ɛ {c}_{t + 1} )}{ɛ {c}_{t}} < threshold$$

threshold
which is about 10⁻³, ecₜ being the error committed at the instant t that represents the iteration.

There follows a matrix T of distances between the terms, where Dᵢⱼ designates the distance between term tᵢ and term tⱼ.

| | t₀ | tᵢ | tₖ | tⱼ | tₙ |
|---|---|---|---|---|---|
| t₀ | D₀₀ | D₀ᵢ | D₀ₖ | D₀ⱼ | D₀ₙ |
| tᵢ | Dᵢ₀ | Dᵢᵢ | Dᵢₖ | Dᵢⱼ | Dᵢₙ |
| tₖ | Dₖ₀ | Dₖᵢ | Dₖₖ | Dₖⱼ | Dₖₙ |
| tⱼ | Dⱼ₀ | Dⱼᵢ | Dⱼₖ | Dⱼⱼ | Dⱼₙ |
| tₙ | Dₙ₀ | Dₙᵢ | Dₙₖ | Dₙⱼ | Dₙₙ |

For multimedia documents having a variety of contents, FIG. 13 shows an example of how the concept dictionary 505 is structured.

In order to facilitate navigation inside the dictionary 505 and determine quickly during an identification stage the concept that is closest to a given term, the dictionary 505 is analyzed and a navigation chart 509 inside the dictionary is established.

The navigation chart 509 is produced iteratively. On each iteration, the set of concepts is initially split into two subsets, and then on each iteration, one of the subsets is selected until the desired number of groups is obtained or until the stop criterion is satisfied. The stop criterion may be, for example, that the resulting subsets are all homogeneous with a small standard deviation, for example. The final result is a binary tree in which the leaves contain the concepts of the dictionary and the nodes of the tree contain the information necessary for traversing the tree during the stage of identifying a document.

There follows a description of an example of the module 506 for distributing a set of concepts.

The set of concepts C is represented in the form of a matrix M=[c₁, c₂, . . . , c_{N}]∈ [symbol] ^{p·N}, where cᵢ ∈ [symbol] ^{p}, where cᵢ represents a concept having p values. Various methods can be used for obtaining an axial distribution. The first step is to calculate the center of gravity C and the axis used for decomposing the set into two subsets.

The processing steps are as follows:

Step 1: calculating a representative of the matrix M such as the centroid w of matrix M:

$$w = \frac{1}{N} {\sum }_{i = 1}^{N} {c}_{i} \qquad ( 13 )$$

Step 2: calculating the covariance matrix \tilde{M} between the elements of the matrix M and the representative of the matrix M, giving in the above special case
\tilde{M}=M−we, where e=[1,1,1, . . . ,1] (14)

Step 3: calculate an axis for projecting the elements of the matrix M, e.g. the eigenvector U associated with the greatest eigenvalue of the covariance matrix.

Step 4: calculate the value pi=U^{T}(cᵢ−w) and decompose the set of concepts C into two substeps C1 and C2 as follows:

$$\{ \begin{matrix}{c}_{i} ∈ C 1 & if pi \leq 0 \\ {c}_{i} ∈ C 2 & if pi > 0\end{matrix} \qquad ( 15 )$$

The data set stored in the node associated with C is {u, w, |p1|, p2 } where p1 is the maximum of all pi≦0 and p2 is the minimum of all pi>0.

The data set {u, w, |p1|, p2 } constitutes the navigation indicators in the concept dictionary. Thus, during the identification stage for example, in order to determine the concept that is closest to a term tᵢ, the value pti=u^{T}(tᵢ−w) is calculated and then the node associated with C1 is selected if |(|pti|−|p1|)|<|(|pti|−p2)|, else the node C2 is selected. The process is iterated until one of the leaves of the tree has been reached.

A singularity detector module 508 may be associated with the concept distribution module 506.

The singularity detector serves to select the set Ci that is to be decomposed. One of the possible methods consists in selecting the less compact set.

FIGS. 14 and 15 show the indexing of a document or a document base and the construction of a fingerprint base 510.

The fingerprint base 510 is constituted by the set of concepts representing the terms of the documents to be protected. Each concept Ci of the fingerprint base 510 is associated with a fingerprint 511, 512, 513 constituted by a data set such as the number of terms in the documents where the concept is present, and for each of these documents, a fingerprint 511a, 511b, 511c is registered comprising the address of the document DocIndex, the number of terms, the number of occurrences of the concept (frequency), the score, and the concepts that are adjacent thereto in the document. The score is a mean value of similarity measurements between the concept and the terms of the document which are closest to the concept. The address DocIndex of a given document is stored in a database 514 containing the addresses of protected documents.

The process 520 for generating fingerprints or signatures of the documents to be indexed is shown in FIG. 15.

When a document DocIndex is registered, the pertinent terms are extracted from the document (step 521), and the concept dictionary is taken into account (step 522). Each of the terms tᵢ of the document DocIndex is projected into the space of the concepts dictionary in order to determine the concept cᵢ that represents the term tᵢ (step 523).

Thereafter the fingerprint of concept cᵢ is updated (step 524). This updating is performed depending on whether or not the concept has already been encountered, i.e. whether it is present in the documents that have already been registered.

If the concept cᵢ is not yet present in the database, then a new entry is created in the database (an entry in the database corresponds to an object made up of elements which are themselves objects containing the signature of the concept in those documents where the concept is present). The newly created event is initialized with the signature of the concept. The signature of a concept in a document DocIndex is made up mainly of the following data items: DocIndex, number of terms, frequency, adjacent concepts, and score.

If the concept cᵢ exists in the database, then the entry associated with the concept has added thereto its signature in the query document, which signature is made up of (DocIndex, number of terms, frequency, adjacent concepts, and score).

Once the fingerprint base has been constructed (step 525), the fingerprint base is registered (step 526).

FIG. 16 shows a process of identifying a document that is implemented on an on-line search platform 530.

The purpose of identifying a document is to determine whether a document presented as a query constitutes reutilization of a document in the database. It is based on measuring the similarity between documents. The purpose is to identify documents containing protected elements. Copying can be total or partial. When partial, the copied element will have been subjected to modifications such as: eliminating sentences from a text, eliminating a pattern from an image, eliminating a shot or a sequence from a video document, . . . , changing the order of terms, or substituting terms with other terms in a text.

After presenting a document to be identified (step 531), the terms are extracted from that document (step 532).

In association with the fingerprint base (step 525), the concepts calculated from the terms extracted from the query are put into correspondence with the concepts of the database (step 533) in order to draw up a list of documents having contents similar to the content of the query document.

The process of establishing the list is as follows:

P_{dj} designates the degree of resemblance between document dj and the query document, with 1≦j≦N, where N is the number of documents in the reference database.

All P_{dj} are initialized to zero.

For each term tᵢ in the query provided in step 731 (FIG. 17), the concept Ci that represents it is determined (step 732).

For each document dj where the concept is present, its P_{dj} is updated as follows:
P_{dj}=P_{dj}+f(frequency, score)
where several functions f can be used, e.g.:
f(frequency, score)=frequency×score
where frequency designates the number of occurrences of concept Ci in document dj and where score designates the mean of the resemblance scores of the terms of document dj with concept Cj.

The P_{dj} are ordered, and those that are greater than a given threshold (step 733) are retained. Then the responses are confirmed and validated (step 534).

Response confirmation: the list of responses is filtered in order to retain only the responses that are the most pertinent. The filtering used is based on the correlation between the terms of the query and each of the responses.

Validation: this serves to retain only those responses where it is very certain that content has been reproduced. During this step, responses are filtered, taking account of algebraic and topological properties of the concepts within a document: it is required that neighborhood in the query document is matched in the response documents, i.e. two concepts that are neighbors in the query document must also be neighbors in the response document.

The list of response documents is delivered (step 535).

Consideration is given below in greater detail to multimedia documents that contain images.

The description bears in particular on building up the fingerprint base that is to be used as a tool for identifying a document, based on using methods that are fast and effective for identifying images and that take account of all of the pertinent information contained in the images going from characterizing the structures of objects that make them up, to characterizing textured zones and background color. The objects of the image are identified by producing a table summarizing various statistics made on information about object boundary zones and information on the neighborhoods of said boundary zones. Textured zones can be characterized using a description of the texture that is very fine, both spatially and spectrally, based on three fundamental characteristics, namely its periodicity, its overall orientation, and the random appearance of its pattern. Texture is handled herein as a two-dimensional random process. Color characterization is an important feature of the method. It can be used as a first sort to find responses that are similar based on color, or as a final decision made to refine the search.

In the initial stage of building up fingerprints, account is taken of information classified in the form of components belonging to two major categories:
so-called “structural” components that describe how the eye perceives an object that may be isolated or a set of objects placed in an arrangement in three dimensions; and
so-called “textural” components that complement structural components and represent the regularity or uniformity of texture patterns.

As mentioned above, during the stage of building fingerprints, each document in the document base is analyzed so as to extract pertinent information therefrom. This information is then indexed and analyzed. The analysis is performed by a string of procedures that can be summarized as three steps:
for each document, extracting predefined characteristics and storing this information in a “term” vector;
grouping together in a concept all of the terms that are “neighboring” from the point of view of their characteristics, thus enabling searching to be made more concise; and
building a fingerprint that characterizes the document using a small number of entities. Each document is thus associated with a fingerprint that is specific thereto.

In a subsequent search stage, following a request made by a user, e.g. to identify a query image, a search is made for all multimedia documents that are similar or that comply with the request. To do this, as mentioned above, the terms of the query document are calculated and they are compared with the concepts of the databases in order to deduce which document(s) of the database is/are similar to the query document.

The stage of constructing the terms of an image is described in greater detail below.

The stage of constructing the terms of an image usefully implements characterization of the structural supports of the image. Structural supports are elements making up a scene of the image. The most significant are those that define the objects of the scene since they characterize the various shapes that are perceived when any image is observed.

This step concerns extracting structural supports. It consists in dismantling boundary zones of image objects, where boundaries are characterized by locations in which high levels of intensity variation are observed between two zones. This dismantling operates by a method that consists in distributing the boundary zones amongst a plurality of “classes” depending on the local orientation of the image gradient (the orientation of the variation in local intensity). This produces a multitude of small elements referred to as structural support elements (SSE). Each SSE belongs to an outline of a scene and is characterized by similarity in terms of the local orientation of its gradient. This is a first step that seeks to index all of the structural support elements of the image.

The following process is then performed on the basis of these SSEs, i.e. terms are constructed that describe the local and global properties of the SSEs.

The information extracted from each support is considered as constituting a local property. Two types of support can be distinguished: straight rectilinear elements (SRE), and curved arcuate elements (CAE).

The straight rectilinear elements SRE are characterized by the following local properties:
dimension (length, width);
main direction (slope);
statistical properties of the pixels constituting the support (mean energy value, moments); and
neighborhood information (local Fourier transform).

The curved arcuate elements CAE are characterized in the same manner as above, together with the curvature of the arcs.

Global properties cover statistics such as the numbers of supports of each type and their dispositions in space (geometrical associations between supports: connexities, left, right, middle, . . . ).

To sum up, for a given image, the pertinent information extracted from the objects making up the image is summarized in Table 1.

TABLE 1

| | |
|---|---|
| Structural supports of | Type |

| | | | |
|---|---|---|---|
| objects of an image | SSE | SRE | CAE |

| | | | | |
|---|---|---|---|---|
| Global | Total number | n | n₁ | n₂ |
| properties | Number long | nl | n₁l | n₂l |
| | (>threshold) | | | |
| | Number short | nc | n₁c | n₂c |
| | (<threshold) | | | |
| | Number of long | — | n₁lgdx | n₂lgdx |
| | supports at a | | | |
| | left or right | | | |
| | connection | | | |
| | Number of middle | — | n₁lgdx | n₂lgdx |
| | connection | | | |
| | Number of | — | n₁pll | n₂pll |
| | parallel long | | | |
| | supports | | | |
| Local | Luminance | — | | |
| properties | (>threshold) | | | |
| | Luminance | — | | |
| | (<threshold) | | | |
| | Slope | — | | |
| | Curvature | — | | |
| | Characterization | — | | |
| | of the neighborhood | | | |
| | of the supports | | | |

The stage of constructing the terms of an image also implements characterizing pertinent textual information of the image. The information coming from the texture of the image is subdivided by three visual appearances of the image:
random appearance (such as an image of fine sand or grass) where no particular arrangement can be determined;
periodic appearance (such as a patterned knit) or a repetition of dominant patterns (pixels or groups of pixels) is observed; and finally
a directional appearance where the patterns tend overall to be oriented in one or more privileged directions.

This information is obtained by approximating the image using parametric representations or models. Each appearance is taken into account by means of the spatial and spectral representations making up the pertinent information for this portion of the image. Periodicity and orientation are characterized by spectral supports while the random appearance is represented by estimating parameters for a two-dimensional autoregressive model.

Once all of the pertinent information has been extracted, it is possible to proceed with structuring texture terms.

TABLE 2

Spectral supports and autoregressive
parameters of the texture of an image

| | | |
|---|---|---|
| Periodic component | Total number of | np |
| | periodic elements | |
| | Frequencies | Pair (ωₚ, vₚ), |
| | | 0 < p ≦ np |
| | Amplitudes | Pair (Cₚ, Dₚ), |
| | | 0 < p ≦ np |
| Directional component | Total number of | nd |
| | directional | |
| | elements | |
| | Orientations | Pair (αᵢ, βᵢ), |
| | | 0 < p ≦ np |
| | Frequencies | vᵢ, 0 < i ≦ nd |
| Random components | Noise standard | σ |
| | deviation | |
| | Autoregressive | {a_{i, j}}, (i, j) ∈ S_{N, M} |
| | parameters | |

Finally, the stage of constructing the terms of an image can also implement characterizing the color of the image.

Color is often represented by color histograms, which are invariant in rotation and robust against occlusion and changes in camera viewpoint.

Color quantification can be performed in the red, green, blue (RGB) space, the hue, saturation, value (HSV) space, or the LUV space, but the method of indexing by color histograms has shown its limitations since it gives global information about an image, so that during indexing it is possible to find images that have the same color histogram but that are completely different.

Numerous authors propose color histograms that integrate spatial information. For example this can consist in distinguishing between pixels that are coherent and pixels that are incoherent, where a pixel is coherent if it belongs to a relatively large region of identical pixels, and is incoherent if it forms part of a region of small size.

A method of characterizing the spatial distribution of the constituents of an image (e.g. its color) is described below that is less expensive in terms of computation time than the above-mentioned methods, and that is robust faced with rotations and/or shifts.

The various characteristics extracted from the structural support elements, the parameters of the periodic, directional, and random components of the texture field, and also the parameters of the spatial distribution of the constituents of the image, constitute the “terms” that can be used for describing the content of a document. These terms are grouped together to constitute “concepts” in order to reduce the amount of “useful information” of a document.

The occurrences of these concepts and their positions and frequencies constitute the “fingerprint” of a document. These fingerprints then act as links between a query document and documents in a database while searching for a document.

An image does not necessarily contain all of the characteristic elements described above. Consequently, identifying an image begins with detecting the presence of its constituent elements.

In an example of a process of extracting terms from an image, a first step consists in characterizing image objects in terms of structural supports, and, where appropriate, it may be preceded by a test for detecting structural elements, which test serves to omit the first step if there are no structural elements.

A following step is a test for determining whether there exists a textured background. If so, the process moves on to a step of characterizing the textured background in terms of spectral supports and autoregressive parameters, followed by a step of characterizing the background color.

If there is no structured background, then the process moves directly to the step of characterizing background color.

Finally, the terms are stored and fingerprints are built up.

The description returns in greater detail to characterizing the structural support elements of an image.

The principle on which this characterization is based consists in dismantling boundary zones of image objects into multitudes of small base elements referred to as significant support elements (SSEs) conveying useful information about boundary zones that are made up of linear strips of varying size, or of bends having different curvatures. Statistics about these objects are then analyzed and used for building up the terms of these structural supports.

In order to describe more rigorously the main methods involved in this approach, a digitized image is written as being the set {y(i, j), (i, j) ∈ I×J}, where I and J are respectively the number of rows and the number of columns in the image.

On the basis of previously calculated vertical gradient images {gᵥ(i, j), (i, j) ∈ I×J} and horizontal gradient images {gₕ(i, j), (i, j) ∈ I×J}, this approach consists in partitioning the image depending on the local orientation of its gradient into a finite number of equidistant classes. The image containing the orientation of the gradient is defined by the following formula:

$$O ( i , j ) = arctan ( \frac{{g}_{h} ( i , j )}{{g}_{v} ( i , j )} ) \qquad ( 1 )$$

A partition is no more than an angular decomposition in the two-dimensional (2D) plane (from 0° to 360°) using a well-defined quantization pitch. By using the local orientation of the gradient as a criterion for decomposing boundary zones, it is possible to obtain a better grouping of pixels that form parts of the same boundary zone. In order to solve the problem of boundary points that are shared between two juxtaposed classes, a second partitioning is used, using the same number of classes as before, but offset by half a class. On the basis of these classes coming from the two partitionings, a simple procedure consists in selecting those that have the greatest number of pixels. Each pixel belongs to two classes, each coming from a respective one of the two partitionings. Given that each pixel is potentially an element of an SSE, if any, the procedure opts for the class that contains the greater number of pixels amongst those two classes. This constitutes a region where the probability of finding an SSE of larger size is the greatest possible. At the end of this procedure, only those classes that contain more than 50% of the candidates are retained. These are regions of the support that are liable to contain SSEs.

From these support regions, SSEs are determined and indexed using certain criteria such as the following:
length (for this purpose a threshold length l₀ is determined and SSEs that are shorter and longer than the threshold are counted);
intensity, defined as the mean of the modulus of the gradient of the pixels making up each SSE (a threshold written I₀ is then defined, and SSEs that are below or above the threshold are indexed); and
contrast, defined as the difference between the pixel maximum and the pixel minimum.

At this step in the method, all of the so-called structural elements are known and indexed in compliance with pre-identified types of structural support. They can be extracted from the original image in order to leave room for characterizing the texture field.

In the absence of structural elements, it is assumed that the image is textured with patterns that are regular to a greater or lesser extent, and the texture field is then characterized. For this purpose, it is possible to decompose the image into three components as follows:
a textural component containing anarchic or random information (such as an image of fine sand or grass) in which no particular arrangement can be determined;
a periodic component (such as a patterned knit) in which repeating dominant patterns are observed; and finally
a directional component in which the patterns tend overall towards one or more privileged directions.

Since the idea is to characterize accurately the texture of the image on the basis of a set of parameters, these three components are represented by parametric models.

Thus, the texture of the regular and homogeneous image 15 written {y(i, j), (i, j) ∈ I×J} is decomposed into three components 16, 17, and 18 as shown in FIG. 10, using the following relationship:
{\tilde{y}(i,j)}={w(i,j)}+{h(i,j)}+{e(i,j)}. (16)

Where {w(i, j)} is the purely random component 16, {h-(i, j)} is the harmonic component 17, and {e(i, j)} is the directional component 18. This step of extracting information from a document is terminated by estimating parameters for these three components 16, 17, and 18. Methods of making such estimates are described in the following paragraphs.

The description begins with an example of a method for detecting and characterizing the directional component of the image.

Initially it consists in applying a parametric model to the directional component {e(i, j)}. It is constituted by a denumerable sum of directional elements in which each is associated with a pair of integers (α, β) defining an orientation of angle θ such that θ=tan⁻¹β/α. In other words, e(i, j) is defined by:

$$e ( i , j ) = {\sum }_{( α , β ) ∈ O} {e}_{( α , β )} ( i , j )$$

in which each e_{(α, β)} (i, j) is defined by:

$${e}_{( α , β )} = ( i , j ) = {\sum }_{k = 1}^{Ne} [ {s}_{k}^{α , β} ( i α - j β ) \times cos ( 2 π \frac{{v}_{k}}{{α}^{2} + {β}^{2}} ( i β + j α ) ) + {t}_{k}^{α , β} ( i α - j β ) \times sin ( 2 π \frac{{v}_{k}}{{α}^{2} + {β}^{2}} ( i β + j α ) ) ] \qquad ( 17 )$$

where:
Ne is the number of directional elements associated with (α, β);
vₖ is the frequency of the k^{th} element; and
{sₖ(iα−jβ)} and {tₖ(iα−jβ)} are the amplitudes.

The directional component {e(i, j)} is thus completely defined by knowing the parameters contained in the following vector E:
E={αₗ,βₗ,{ᵥ_{ₗₖ},ₛ_{ₗₖ}(c),tₗₖ(c)}₁ₖ₌₁^{N}^{ₑ}}_{(α}_{ⱼ},₆₂ _{ⱼ})∈O (18)

In order to estimate these parameters, use is made of the fact that the directional component of an image is represented in the spectral domain by a set of straight lines of slopes orthogonal to those defined by the pairs of integers (α₁, β₁) of the model which are written (α₁, β₁)^{⊥}. These straight lines can be decomposed into subsets of same-slope lines each associated with a directional element.

In order to calculate the elements of the vector E, it is possible to adopt an approach based on projecting the image in different directions. The method consists initially in making sure that a directional component is present before estimating its parameters.

The directional component of the image is detected on the basis of knowledge about its spectral properties. If the spectrum of the image is considered as being a three-dimensional image (X, Y, Z) in which (X, Y) represent the coordinates of the pixels and Z represents amplitude, then the lines that are to be detected are represented by a set of peaks concentrated along lines of slopes that are defined by the looked-for pairs (αₗ, βₗ). In order to determine the presence of such lines, it suffices to count the predominant peaks. The number of these peaks provides information about the presence or absence of harmonics or directional supports.

There follows a description of an example of the method of characterizing the directional component. To do this, direction pairs (αₗ, βₗ) are calculated and the number of directional elements is determined.

The method begins with calculating the discrete Fourier transform (DFT) of the image followed by an estimate of the rational slope lines observed in the transformed image ψ(i, j).

To do this, a discrete set of projections is defined subdividing the frequency domain into different projection angles θₖ, where k is finite. This projection set can be obtained in various ways. For example it is possible to search for all pairs of mutually prime integers (αₖ, βₖ) defining an angle θₖ such that

$${θ}_{k} = {tan}^{- 1} \frac{{α}_{k}}{{β}_{k}}$$

where

$$0 \leq {θ}_{k} \leq \frac{π}{2} .$$

An order r such that 0≦αₖ, βₖ≦r serves to control the number of projections. Symmetry properties can then be used for obtaining all pairs up to 2π.

The projections of the modulus of the DFT of the image are performed along the angle θₖ. Each projection generates a vector of dimension 1, V_{(α}_{ₖ}_{, β}_{ₖ}₎, written Vₖ to simplify the notation, which contains the looked-for directional information.

Each projection Vₖ is given by the formula:

$${V}_{k} ( i , j ) = {\sum }_{τ} Ψ ( i + τ {β}_{k} , j + τ {α}_{k} ) , \\ 0 < i + τ {β}_{k} < I - 1 , 0 < j + τ {α}_{k} < J - 1 \qquad ( 19 )$$

with n=−i*βₖ+j*αₖ and 0≦|n|<Nₖ and Nₖ=|αₖ|(T−1)+|βₖ|(L−1)+1, page 40 where T*L is the size of the image. ψ(i, j) is the modulus of the Fourier transform of the image to be characterized.

For each Vₖ, the high energy elements and their positions in space are selected. These high energy elements are those that present a maximum value relative to a threshold that is calculated depending on the size of the image.

At this stage of the calculation, the number of lines is known. The number of directional components Ne is deduced therefrom by using the simple spectral properties of the directional component of a textured image. These properties are as follows:

1) The lines observed in the spectral domain of a directional component are symmetrical relative to the origin. Consequently, it is possible to reduce the investigation domain to cover only half of the domain under consideration.

2) The maximums retained in the vector are candidates for representing lines belonging to directional elements. On the basis of knowledge of the respective positions of the lines on the modulus of the discrete Fourier transform DFT, it is possible to deduce the exact number of directional elements. The position of the line maximum corresponds to the argument of the maximum of the vector Vₖ, the other lines of the same element being situated every min{L, T}.

After processing the vectors Vₖ and producing the direction pairs (\hat{α}ₖ, \hat{β}ₖ), the numbers of lines obtained with each pair are obtained.

It is thus possible to count the total number of directional elements by using the two above-mentioned properties, and the pairs of integers (\hat{α}ₖ, \hat{β}ₖ) associated with these components are identified, i.e. the directions that are orthogonal to those that have been retained.

For all of these pairs (\hat{α}ₖ, \hat{β}ₖ), estimating the frequencies of each detected element can be done immediately. If consideration is given solely to the points of the original image along the straight line of equation i\hat{α}ₖ−j\hat{β}ₖ=c, then c is the position of the maximum in Vk, and these points constitute a harmonic one-dimensional signal (1D) of constant amplitude at a frequency \hat{v}_{(α, β)}ⁱ. It then suffices to estimate the frequency of this 1D signal by a conventional method (locating the maximum value on the 1D DFT of this new signal).

To summarize, it is possible to implement the method comprising the following steps:

Determining the maximum of each projection.

The maximums are filtered so as to retain only those that are greater than a threshold.
For each maximum mi corresponding to a pair (\hat{α}ₖ, \hat{β}ₖ).
The number of lines associated with said pair is determined from the above-described properties.
The frequency associated with (\hat{α}ₖ, \hat{β}ₖ) is calculated, corresponding to the intersection of the horizontal axis and the maximum line (corresponding to the maximum of the retained projection).

There follows a description of how the amplitudes {ŝₖ^{(α, β)}(t)} and {\hat{t}ₖ^{(α, β)}(t)} are calculated, which are the other parameters contained in the above-mentioned vector E.

Given the direction (\hat{α}ₖ, \hat{β}ₖ) and the frequency Vₖ, it is possible to determine the amplitudes Ŝₖ^{(α, β)}(C) and \hat{t}ₖ^{(α, β)}(C), for c satisfying the formula i\hat{α}ₖ−j\hat{β}ₖ=c, using a demodulation method. Ŝₖ^{(α, β)}(c) is equal to the mean of the pixels along the straight line of equation i\hat{α}ₖ−j\hat{β}ₖ=c of the new image that is obtained by multiplying \tilde{y}(i, j) by:

$$cos ( \frac{{\hat{v}}_{k}^{( α , β )}}{{\hat{α}}_{k}^{2} + {\hat{β}}_{k}^{2}} ( i {\hat{β}}_{k} + j {\hat{α}}_{k} ) )$$

This can be written as follows:

$${\hat{s}}_{k}^{( α , β )} ( c ) ≅ \frac{1}{{N}_{s}} {\sum }_{i \hat{α} - j \hat{β} = c} \tilde{y} ( i , j ) cos ( \frac{{\hat{v}}_{k}^{( α , β )}}{{\hat{α}}_{k}^{2} + {\hat{β}}_{k}^{2}} ( i {\hat{β}}_{k} + j {\hat{α}}_{k} ) ) \qquad ( 20 )$$

where Nₛ is the number of elements in this new signal. Similarly, \hat{t}ₖ^{(α, β)}(c) can be obtained by applying the equation:

$${\hat{t}}_{k}^{( α , β )} ( c ) ≅ \frac{1}{{N}_{s}} {\sum }_{i \hat{α} - j \hat{β} = c} \tilde{y} ( i , j ) sin ( \frac{{\hat{v}}_{k}^{( α , β )}}{{\hat{α}}_{k}^{2} + {\hat{β}}_{k}^{2}} ( i {\hat{β}}_{k} + j {\hat{α}}_{k} ) ) \qquad ( 21 )$$

The above-described method can be summarized by the following steps:

For every directional element (\hat{α}ₖ, \hat{β}ₖ), do
For every line (d), calculate
1) The mean of the points (i, j) weighted by:

$$cos ( \frac{{\hat{v}}_{k}^{( α , β )}}{{\hat{α}}_{k}^{2} + {\hat{β}}_{k}^{2}} ( i {\hat{β}}_{k} + j {\hat{α}}_{k} ) )$$

This mean corresponds to the estimated amplitude ŝₖ^{(α, β)}(d).
2) The mean of the points (i, j) weighted by:

$$sin ( \frac{{\hat{v}}_{k}^{( α , β )}}{{\hat{α}}_{k}^{2} + {\hat{β}}_{k}^{2}} ( i {\hat{β}}_{k} + j {\hat{α}}_{k} ) )$$

This mean corresponds to the estimated amplitude \hat{t}ₖ^{(α, β)}(d).

Table 3 below summarizes the main steps in the projection method.

TABLE 3

Step 1. Calculate the set of projection pairs (αₖ, βₖ) ∈ Pᵣ.
Step 2. Calculate the modulus of the DFT of the image
\tilde{y}(i,j): Ψ(ω,ν)=|DFT(y(i,j))|
Step 3. For every (αₖ, βₖ) ∈ Pᵣ calculate the vector Vₖ:
the projection of ψ (w,v) along (αₖ, βₖ) using equation (19).
Step 4: Detecting lines:
For every (αₖ, βₖ) ∈ Pᵣ
$determine \text{:} {M}_{k} = {max}_{j} \{ {V}_{k} ( j ) \} ;$
calculate nₖ, the number of pixels of significant

value encountered along the projection

save nₖ and jₘₐₓ the index of the maximum in Vₖ
$select the directions that satisfy the criterion \text{:} \frac{{M}_{k}}{{n}_{k}} > {s}_{e}$

where sₑ is a threshold to be defined, depending on the size of the image.
The directions that are retained are considered as being
the directions of the looked-for lines.
Step 5. Save the looked-for pairs (\hat{α}ₖ, \hat{β}ₖwhich are the
orthogonals of the pairs (αₖ, βₖ) retained in step 4.

There follows a description of detecting and characterizing periodic textural information in an image, as contained in the harmonic component {h(i, j)}. This component can be represented as a finite sum of 2D sinewaves:

$$h ( i , j ) = {\sum }_{p = 1}^{P} {C}_{p} cos 2 π ( i {ω}_{p} + j {v}_{p} ) + {D}_{p} sin 2 π ( i {ω}_{p} + j {v}_{p} ) , \qquad ( 22 )$$

where:
c_{P} and Dₚ are amplitudes;
(ωₚ, vₚ) is the p^{th} spatial frequency.

The information that is to be determined is constituted by the elements of the vector:
H={P,{Cₚ,Dₚ,ωₚ,νₚ}ₚ₌₁^{p}} (23)

For this purpose, the procedure begins by detecting the presence of said periodic component in the image of the modulus of the Fourier transform, after which its parameters are estimated.

Detecting the periodic component consists in determining the presence of isolated peaks in the image of the modulus of the DFT. The procedure is the same as when determining the directional components. From the method described in Table 1, if the value nₖ obtained during stage 4 of the method described in Table 1 is less than a threshold, then isolated peaks are present that characterize the presence of a harmonic component, rather than peaks that form a continuous line.

Characterizing the periodic component amounts to locating the isolated peaks in the image of the modulus of the DFT.

These spatial frequencies (\hat{ω}ₚ, \hat{ν}ₚ) correspond to the positions of said peaks:

$$( {\hat{ω}}_{p} , {\hat{v}}_{p} ) = {arg max}_{( ω , v )} Ψ ( ω , v ) \qquad ( 24 )$$

In order to calculate the amplitudes (Ĉₚ, \hat{D}ₚ) a demodulation method is used as for estimating the amplitudes of the directional component.

For each periodic element of frequency (\hat{ω}ₚ, \hat{ν}ₚ), the corresponding amplitude is identical to the mean of the pixels of the new image obtained by multiplying the image {\tilde{y}(i, j)} by cos(i\hat{ω}ₚ+j\hat{ν}ₚ) . This is represented by the following equations:

$$\begin{matrix}{\hat{C}}_{p} = \frac{1}{L \times T} {\sum }_{n = 0}^{L - 1} {\sum }_{m = 0}^{T - 1} y ( n , m ) cos ( n {\hat{ω}}_{p} + m {\hat{v}}_{p} ) & ( 25 ) \\ {\hat{D}}_{p} = \frac{1}{L \times T} {\sum }_{n = 0}^{L - 1} {\sum }_{m = 0}^{T - 1} y ( n , m ) cos ( n {\hat{ω}}_{p} + m {\hat{v}}_{p} ) & ( 26 )\end{matrix}$$

To sum up, a method of estimating the periodic component comprises the following steps:

| | |
|---|---|
| Step 1. | Locate the isolated peaks in the second half of |
| | the image of the modulus of the Fourier transform and |
| | count the number of peaks. |
| Step 2. | For each detected peak: |
| | calculate its frequency using equation (24); |
| | calculate its amplitude using equations (25-26). |

The last information to be extracted is contained in the purely random component {w(i, j)}. This component may be represented by a 2D autoregressive model of the non-symmetrical half-plane support (NSHP) defined by the following difference equation:

$$w ( i , j ) = - {\sum }_{( k , l ) ∈ {S}_{N , M}} {a}_{k , l} w ( i - k , j - l ) + u ( i , j ) \qquad ( 27 )$$

where {a_{(k, l)}}_{(k, l)εS}_{_{N,M}} are the parameters to be determined for every (k, l) belong to:
S_{N,M}={(k,l)/k=0,1≦l≦M}∪{(k,l)/1≦k≦N, −M≦l≦M}
The pair (N,M) is known as the order of the model
{u(i, j)} is Gaussian white noise of finite variance σᵤ².
   The parameters of the model are given by:
   W={(N,M),σᵤ²,{a_{k,l}}_{(k,l)εS}_{_{N,M}}} (28)

The methods of estimating the elements of W are numerous, such as for example the 2D Levinson algorithm for adaptive methods of the least squares type (LS).

There follows a description of a method of characterizing the color of an image from which it is desired to extract terms tᵢ representing characteristics of the image, where color is a particular example of characteristics that can comprise other characteristics such as algebraic or geometrical moments, statistical properties, or the spectral properties of pseudo-Zernicke moments.

The method is based on perceptual characterization of color, firstly, the color components of the image are transformed from red, green, blue (RGB) space to hue, saturation, value (HSV) space. This produces three components: hue, saturation, value. On the basis of these three components, N colors or iconic components of the image are determined. Each iconic component Ci is represented by a vector of M values. These values represent the angular and annular distribution of points representing each component, and also the number of points of the component in question.

The method developed is shown in FIG. 9 using, by way of example, N=16 and M=17.

In a first main step 610, starting from an image 611 in RGB space, the image 611 is transformed from RGB space into HSV space (step 612) in order to obtain an image in HSV space.

The HSV model can be defined as follows.

Hue (H): varies over the range [0 360], where each angle represents a hue.

Saturation (S); varies over the range [0 1], measuring the purity of colors, thus serving to distinguish between colors that are “vivid” , “pastel” , or “faded” .

Value (V): takes values in the range [0 1], indicates the lightness or darkness of a color and the extent to which it is close to white or black.

The HSV model is a non-linear transformation of the RGB model. The human eye can distinguish 128 hues, 130 saturations, and 23 shades.

For white, V=1 and S=0, black has a value V=0, and hue and saturation H and S are undetermined. When V=1 and S=1, then the color is pure.

Each color is obtained by adding black or white to the pure color.

In order to have colors that are lighter, S is reduced while maintaining H and V, and in contrast in order to have colors that are darker, black is added by reducing V while leaving H and S unchanged.

Going from the color image expressed in RGB coordinates to an image expressed in HSV space, is performed as follows:

For every point of coordinates (i, j) and of value (Rₖ, Gₖ, Bₖ) produce a point of coordinates (i, j) and of value (Hₖ, Sₖ, Vₖ), with:
Vₖ=max(Rₖ,Bₖ,Gₖ)

$${S}_{k} = \frac{{V}_{k} - min ( {R}_{k} , {G}_{k} , {B}_{k} )}{{V}_{k}}$$

if Vₖ is equal to Rₖ

$$\{ \begin{matrix}\frac{{G}_{k} - {B}_{k}}{{V}_{k} - min ( {R}_{k} , {G}_{k} , {B}_{k} )} & if {V}_{k} is equal to {R}_{k}\end{matrix}$$

$$\begin{matrix}{H}_{k} = & 2 + \frac{{B}_{k} - {R}_{k}}{{V}_{k} - min ( {R}_{k} , {G}_{k} , {B}_{k} )} & if {V}_{k} is equal to {G}_{k} \\ & 4 + \frac{{R}_{k} - {G}_{k}}{{V}_{k} - min ( {R}_{k} , {G}_{k} , {B}_{k} )} & if {V}_{k} is equal to {B}_{k}\end{matrix}$$

if Vₖ is equal to Gₖ
if Vₖ is equal to Bₖ

Thereafter, the HSV space is partitioned (step 613).

N colors are defined from the values given to hue, saturation, and value. When N equals 16, then the colors are as follows: black, white, pale gray, dark gray, medium gray, red, pink, orange, brown, olive, yellow, green, sky blue, blue green, blue, purple, magenta.

For each pixel, the color to which it belongs is determined. Thereafter, the number of points having each color is calculated.

In a second main step 620, the partitions obtained during the first main step 610 are characterized.

In this step 620, an attempt is made to characterize each previously obtained partition Ci. A partition is defined by its iconic component and by the coordinates of the pixels that make it up. The description of a partition is based on characterizing the spatial distribution of its pixels (cloud of points). The method begins by calculating the center of gravity, the major axis of the cloud of points, and the axis perpendicular thereto. This new index is used as a reference in decomposing the partition Ci into a plurality of sub-partitions that are represented by the percentage of points making up each of the sub-partitions. The process of characterizing a partition Ci is as follows:
calculating the center of gravity and the orientation angle of the components Ci defining the partitioning index;
calculating the angular distribution of the points of the partition Ci in the N directions operating counterclockwise, in N sub-partitions defined as follows:

$$( 0 ° , \frac{360}{N} , \frac{2 \times 360}{N} , … , \frac{i \times 360}{N} , … , \frac{( N - 1 ) \times 360}{N} )$$
partitioning the image space into squares of concentric radii, and calculating on each radius the number of points corresponding to each iconic component.

The characteristic vector is obtained from the number of points of each distribution of color Ci, the number of points in the 8 angular sub-distributions, and the number of image points.

Thus, the characteristic vector is represented by 17 values in this example.

FIG. 9 shows the second step 620 of processing on the basis of iconic components C0 to C15 showing for the components C0 (module 621) and C15 (module 631), the various steps undertaken, i.e. angular partitioning 622, 632 leading to a number of points in the eight orientations under consideration (step 623, 633), and annular partitioning 624, 634 leading to a number of points on the eight radii under consideration (step 625, 635), and also taking account of the number of pixels of the component (C0 or C15 as appropriate) in the image (step 626 or step 636).

Steps 623, 625, and 626 produce 17 values for the component C0 (step 627) and steps 633, 635, and 636 produce 17 values for the component C15 (step 637).

Naturally, the process is analogous for the other components C1 to C14.

FIGS. 10 and 11 show the fact that the above-described process is invariant in rotation.

Thus, in the example of FIG. 10, the image is partitioned in two subsets, one containing crosses x and the other circles ◯. After calculating the center of gravity and the orientation angle θ, an orientation index is obtained that enables four angular sub-divisions (0°, 90°, 180°, 270°) to be obtained.

Thereafter, an annular distribution is performed, with the numbers of points on a radius equal to 1 and then on a radius equal to 2 being calculated. This produces the vector V0 characteristic of the image of FIG. 10: 19; 6; 5; 4; 4; 8; 11.

The image of FIG. 11 is obtained by turning the image of FIG. 10 through 90°. By applying the above method to the image of FIG. 11, a vector V1 is obtained characterizing the image and demonstrating that the rotation has no influence on the characteristic vector. This makes it possible to conclude that the method is invariant in rotation.

As mentioned above, methods making it possible to obtain for each image the terms representing the dominant colors, the textural properties, or the structures of the dominant zones of the image, can be applied equally well to the entire image or to portions of the image.

There follows a brief description of the process whereby a document can be segmented in order to produce image portions for characterizing.

In a first possible technique, static decomposition is performed. The image is decomposed into blocks with or without overlapping.

In a second possible technique, dynamic decomposition is performed. Under such circumstances, the image is decomposed into portions as a function of the content of the image.

In a first example of the dynamic decomposition technique, the portions are produced from germs constituted by singularity points in the image (points of inflection). The germs are calculated initially, and they are subsequently fused so that only a small number remain, and finally the image points are fused with the germs having the same visual properties (statistics) in order to produce the portions or the segments of the image to be characterized.

In another technique that relies on hierarchical segmentation, the image points are fused to form n first classes. Thereafter, the points of each of the classes are decomposed into m classes and so on until the desired number of classes is reached. During fusion, points are allocated to the nearest class. A class is represented by its center of gravity and/or a boundary (a surrounding box, a segment, a curve, . . . ).

The main steps of a method of characterizing the shapes of an image are described below.

Shape characterization is performed in a plurality of steps:

To eliminate a zoom effect or variation due to movement of non-rigid elements in an image (movement of lips, leaves on a tree, . . . ), the image is subjected to multiresolution followed by decimation.

To reduce the effect of shifting in translation, the image or image portion is represented by its Fourier transform.

To reduce the zoom effect, the image is defined in polar logarithmic space.

The following steps can be implemented:
a) multiresolution f=wavelet(I, n); where I is the starting image and n is the number of decompositions;
b) projection of the image into logpolar space: g(l, m)=f(i, j) with i=l*cos(m) and j=l*sin(m);
c) calculating the Fourier transform of g: H=FFT(g);
d) characterizing H;
   d1) projecting H in a plurality of directions (0, 45, 90, . . . ): the result is a set of vectors of dimension equal to the dimension of the projection segment;
   d2) calculating the statistical properties of each projection vector (mean, variance, moments).

The term representing shape is constituted by the values of the statistical properties of each projection vector.

Reference is made again to the general scheme of the interception system shown in FIG. 6.

On receiving a suspect document, the comparison module 260 compares the fingerprint of the received document with the fingerprints in the fingerprint base. The role of the comparison function is to calculate a pertinence function, which, for each document, provides a real value indicative of the degree of resemblance between the content of the document and the content of the suspect document (degree of pertinence). If this value is greater than a threshold, the suspect document 211 is considered as containing copies of portions of the document with which it has been compared. An alert is then generated by the means 213. The alert is processed to block dissemination of the document and/or to generate a report 214 explaining the conditions under which the document can be disseminated.

It is also possible to interpose between the module 260 for comparing fingerprints and the module 213 for processing alerts, a module 212 for calculating similarity between documents, which module comprises means for producing a correlation vector representative of a degree of correlation between a concept vector taken in a given order defining the fingerprint of a sensitive document and a concept vector taken in a given order defining the fingerprint of a suspect intercepted document.

The correlation vector makes it possible to determine a resemblance score between the sensitive document and the suspect intercepted document under consideration, and the alert processor means 213 deliver the references of a suspect intercepted document when the value of the resemblance score of said document is greater than a predetermined threshold.

The module 212 for calculating similarity between two documents interposed between the module 260 for comparing fingerprints and the means 213 for processing alerts may present other forms, and in a variant it may comprise:

a) means for producing an interference wave representative of the results of pairing between a concept vector taken in a given order defining the fingerprint of a sensitive document, and a concept vector taken in a given order defining the fingerprint of a suspect intercepted document; and

b) means for producing an interference vector from said interference wave and enabling a resemblance score to be determined between the sensitive document and the suspect intercepted document under consideration.

The means 213 for processing alerts deliver the references of a suspect intercepted document when the value of the resemblance score for said document is greater than a predetermined threshold.

The module 212 for calculating similarity between documents in this variant serves to measure the resemblance score between two documents by taking account of the algebraic and topological property between the concepts of the two documents. For a linear case (text, audio, or video), the principle of the method consists in generating an interference wave that expresses collision between the concepts and their neighbors of the query documents with those of the response documents. From this interference wave, an interference vector is calculated that enables the similarity between the documents to be determined by taking account of the neighborhood of the concepts. For a document having a plurality of dimensions, a plurality of interference waves are produced, one wave per dimension. For an image, for example, the positions of the terms (concepts) are projected in both directions, and for each direction, the corresponding interference wave is calculated. The resulting interference vector is a combination of these two vectors.

There follows a description of an example of calculating an interference wave γ for a document having a single dimension, such as a text type document.

For a text document D and a query document Q, the interference function γ_{D, Q} defined by U (ordered set of pairs (linguistic units: terms or concepts, positions) (u, p) of the document D) and the set E having values lying in the range 0 to 2. When the set is made up of elements having integer values: E={0, 1, 2 }, the function γ_{D, Q} is defined by:
γ_{D, Q(u, p)}=2 [symbol] the linguistic unit “u” does not exist in the query document Q;
γ_{D, Q(u, p)}=1 [symbol] the linguistic unit “u” exists in the query document Q but is isolated;
γ_{D, Q(u, p)}=2 [symbol] the linguistic unit “u” exists in the query document Q and has at least one neighbor “u” that is a neighbor of the linguistic unit “u” in the document D.

The function γ_{D, Q} can be thought of as a signal of amplitude lying entirely in the range 0 to 2 and made up of samples comprising the pairs (ui, pi).

γ_{D, Q} is called the interference wave. It serves to represent the interferences that exist between the documents D and Q. FIG. 18 corresponds to the function (D, Q) of the documents D and Q.

Interference Wave Example

D: “L'enfant de mon voisin va à la piscine après la sortie de l'ècole pour apprendre comment nager, tandis que sa soeur reste à la maison”

[My neighbor's son goes to the swimming pool after leaving school in order to learn to swim, while his sister stays at home]

Q₁: “L'enfant de mon voisin va après l'école en vélo à la piscine pour nager, alors que sa soeur reste à la garderiel”

[My neighbor's child cycles, after school, to the swimming pool to swim, while his sister stays in the nursery]

γ_{D, Q}(enfant)=0 because the word “enfant” is present in D and in Q, and it has the same neighbor in D as in Q.

γ_{D, Q}(enfant)=γ_{D, Q}(va)=γ_{D, Q}(nager)=γ_{D, Q}(soeur)=γ_{D, Q}(reste)=0 for the same reasons.

γ_{D, Q}(piscine)=γ_{D, Q}(école)=1 because the words “piscine” and “école” are present in D and Q but their neighbors in D are not the same as in Q.

γ_{D, Q}(sortie)=γ_{D, Q}(apprendre)=γ_{D, Q}(maison)=2 because the words “sortie” , “apprendre” , and “maison” exist in D but do not exist in Q.

FIG. 19 corresponds to the function (D, Q₂) of the documents D and Q₂.

Q₂: “L'enfant rentre à la maison après l'école”

[The child comes home after school]

The function γ_{D, Q} provides information about the degree of resemblance between D and Q. An analysis of this function makes it possible to identify documents Q which are close to D. Thus, it can be seen that Q1 is closer to D than is Q2.

In order to make γ_{D, Q} easier to analyze, it is possible to introduce two “interference” vectors V₀ and V₁:

V₀ relates to the number of contiguous zeros in γ_{D, Q};

V₁ relates to the number of contiguous ones in γ_{D, Q}.

The dimension of V₀ is equal to the size of the longest sequence of zeros in γ_{D, Q}.

The interference vectors V₀ and V₁ are defined as follows:

The dimension of V₁ has the size of the longest sequence of ones in γ_{D, Q}.

Slot V₀[n] contains the number of sequences of size n at level 0.

Slot V₁[n] contains the number of sequences of size n at level 1.

The interference vectors of the above example are shown in FIGS. 20 and 21.

The case of (D, Q₁) is shown in FIG. 20:

The dimension of V₀ is 3 because the longest sequence at level 0 is of length 3.

The dimension of V₁ is 1 because the longest sequence at level 1 is 1.

The case for (D, Q₂) is shown in FIG. 21:

The vector V₀ is empty since there are no sequences at level 0.

The dimension of V₁ is 1 because the longest sequence at level 1 is of length 1.

To calculate the similarity score for generating alerts, the following function is defined:

$$ω = \frac{α * {\sum }_{j = 1}^{n} j \times {V}_{0} [ j ] + {\sum }_{j = 1}^{m} j \times {V}_{1} [ j ]}{β}$$

where:

ω=similarity score;

V₀=the level 0 interference vector;

V₁=the level 1 interference vector;

T=the size of text document D in linguistic units;

n=the size of the level 0 interference vector:

n=the size of the level 1 interference vector:

α is a value greater than 1, used to give greater importance to zero level sequences. In both examples below, α is taken to be equal to 2;

β=a normalization coefficient, and is equal to 0.02×T in this example.

This formula makes it possible to calculate the similarity score between document D and the query document Q.

The scores in the above example are as follows:
Case (D, Q₁):

$$ω = \frac{2 \times ( 1 \times 0 + 2 \times 0 + 3 \times 2 )}{2 \times 11} \times 100 = \frac{14}{22} \times 100 = 63.63 \%$$

Case (D, Q₂):

$$ω = \frac{( 1 \times 3 )}{2 \times 11} \times 100 = \frac{3}{22} \times 100 = 13.63 \%$$

The process of generating an alert can be as follows:

Initializing the pertinence function: pertinence (i):

For i=0 to i equal to the number of documents, do: pertinence (i)=0;

Extract terms from the suspect document.

For each term determine its concept.

For each concept cⱼ determine the documents in which the concept is present.

For each document dᵢ update its pertinence value: pertinence(dᵢ)=pertinence (dᵢ)+pertinence (dᵢ, cⱼ) with pertinence(dᵢ, cⱼ) being the degree of pertinence of the concept cᵢ in the document dᵢ which depends on the number of occurrences of the concept in the document and on its presence in the other documents of the database: the more the concept is present in the other documents, the more its pertinence is attenuated in the query document.

Select the K documents of value greater than a given threshold.

Correlate the terms of the response documents with the terms of the query document and draw up a new list of responses.

Apply the module 212 to the new list of responses. If the score is greater than a given threshold, the suspect document is considered as containing portions of the elements of the database. An alert is therefore generated.

Consideration is given again to processing documents in the modules 221, 222 for creating document fingerprints (FIG. 6) and the process of extracting terms (step 502) and the process of extracting concepts (step 504) as already mentioned, in particular with reference to FIG. 8.

While indexing a multimedia document comprising video signals, terms tᵢ are selected that are constituted by key-images representing groups of consecutive homogeneous images, and concepts cᵢ are determined by grouping together the terms tᵢ.

Detecting key-images relies on the way images in a video document are grouped together in groups each of which contains only homogeneous images. From each of these groups one or more images (referred to as key-images) are extracted that are representative of the video document.

The grouping together of video document images relies on producing a score vector SV representing the content of the video, characterizing variation in consecutive images of the video (the elements SVᵢ represent the difference between the content of the image of index i and the image of index i−1), with SV being equal to zero when the contents imᵢ and imᵢ₋₁ are identical, and it is large when the difference between the two contents is large.

In order to calculate the signal SV, the red, green, and blue (RGB) bands of each image imᵢ of index i in the video are added together to constitute a single image referred to as TRi. Thereafter the image TRi is decomposed into a plurality of frequency bands so as to retain only the low frequency component LTRi. To do this, two mirror filters (a low pass filter LP and a high pass filter HP) are used which are applied in succession to the rows and to the columns of the image. Two types of filter are considered: a Haar wavelet filter and the filter having the following algorithm:

Row Scanning

From TRk the low image is produced

For each point a_{2×i, j} of the image TR, do

Calculate the point b_{i, j} of the low frequency low image, b_{i, j} takes the mean value of a_{2×i, j-l}, a_{2×i, j}, and a_{2×i, j+1}.

Column Scan

From two low images, the image LTRk is produced

For each point b_{i, 2×j} of the image TR, do

Calculate the point bb_{i, j} of the low frequency low image, bb_{i, j} takes the mean value of b_{i, 2×i, j-l}, b_{i, 2×j}, and b_{i, 2×j+1}.

The row and column scans are applied as often as desired. The number of iterations depends on the resolution of the video images. For images having a size of 512×512, n can be set at three.

The result image LTRi is projected in a plurality of directions to obtain a set of vectors Vk, where k is the projection angle (element j of V0, the vector obtained following horizontal projection of the image, is equal to the sum of all of the points of row j in the image). The direction vectors of the image LTRi are compared with the direction vectors of the image LTRi−1 to obtain a score i which measures the similarity between the two images. This score is obtained by averaging all of the vector distances having the same direction: for each k, the distance is calculated between the vector Vk of image i and the vector Vk of image i−1, and then all of these distances are calculated.

The set of all the scores constitutes the score vector SV: element i of SV measures the similarity between the image LTRi and the image LTRi−1. The vector SV is smoothed in order to eliminate irregularities due to the noise generated by manipulating the video.

There follows a description of an example of grouping images together and extracting key-images.

The vector SV is analyzed in order to determine the key-images that correspond to the maxima of the values of SV. An image of index j is considered as being a key-image if the value SV(j) is a maximum and if SV(j) is situated between two minimums minL (left minimum) and minR (right minimum) and if the minimum M1 where:
M1=min(|SV(Cj)−minG|,|SV(j)−minR|)
is greater than a given threshold.

In order to detect key-images, minL is initialized with SV(0) and then the vector SV is scrolled through from left to right. At each step, the index j corresponding to the maximum value situated between two minimums (minL and minR) is determined, and then as a function of the result of the equation defining M1 it is decided whether or not to consider j as being an index for a key-image. It is possible to take a group of several adjacent key-images, e.g. key-images having indices j−1, j, and j+1.

Three situations arise if the minimum of the two slopes, defined by the two minimums (minL and minR) and the maximum value, is not greater than the threshold:

i) if |SV(j)=minL| is less than the threshold and minL does not correspond to SV(0), then the maximum SV(j) is ignored and minR becomes minL;

ii) if |SV(j)−minL| is greater than the threshold and if |SV(j)−minR| is less than the threshold, then minR and the maximum SV(j) are retained and minL is ignored unless the closest maximum to the right of minR is greater than a threshold. Under such circumstances, minR is also retained and j is declared as being an index of a key-image. When minR is ignored, minR takes the value closest to the minimum situated to the right of minR; and

iii) if both slopes are less than the threshold, minL is retained and minR and j are ignored.

After selecting a key-image, the process is iterated. At each iteration, minR becomes minL.

1. A system of intercepting multimedia documents disseminated from a first network, the system being characterized in that it comprises a module for intercepting and processing packets of information each including an identification header and a data body, the packet interception and processing module comprising first means for intercepting packets disseminated from the first network, means for analyzing the headers of packets in order to determine whether a packet under analysis forms part of a connection that has already been set up, means for processing packets recognized as forming part of a connection that has already been set up to determine the identifier of each received packet and to access a storage container where the data present in each received packet is saved, and means for creating an automaton for processing the received packet belonging to a new connection if the packet header analyzer means show that a packet under analysis constitutes a request for a new connection, the means for creating an automaton comprise in particular means for creating a new storage container for containing the resources needed for storing and managing the data produced by the means for processing packets associated with the new connection, a triplet comprising <identifier, connection state flag, storage container> being created and being associated with each connection by said means for creating an automaton, and in that it further comprises means for analyzing the content of data stored in the containers, for recognizing the protocol used from a set of standard protocols such as in particular http, SMTP, FTP, POP, IMAP, TELNET, P2P, for analyzing the content transported by the protocol, and for reconstituting the intercepted documents.

2. An interception system according to claim 1, characterized in that the analyzer means and the processor means comprise a first table for setting up a connection and containing for each connection being set up an identifier “connectionId” and a flag “connectionState”, and a second table for identifying containers and containing, for each connection that has already been set up, an identifier “connectionId” and a reference “containerRef” identifying the container dedicated to storing the data extracted from the frames of the connection having the identifier “connectionId” .

3. An interception system according to claim 2, characterized in that the flag “connectionState” of the first table for setting up connections can take three possible values depending on whether the detected packet corresponds to a connection request made by a client, to a response made by a server, or to a confirmation made by the client.

4. An interception system according to claim 1, characterized in that the first packet interception means, the packet header analyzer means, the automaton creator means, the packet processor means, and the means for analyzing the content of data stored in the containers operate in independent and asynchronous manner.

5. An interception system according to claim 1, characterized in that it further comprises a first module for storing the content of documents intercepted by the module for intercepting and processing packets, and a second module for storing information relating to at least the sender and the destination of intercepted documents.

6. An interception system according to claim 5, characterized in that it further comprises a module for storing information relating to the components that result from detecting the content of intercepted documents.

7. An interception system according to claim 1, characterized in that it further comprises a centralized system comprising means for producing fingerprints of sensitive documents under surveillance, means for producing fingerprints of intercepted documents, means for storing fingerprints produced from sensitive documents under surveillance, means for storing fingerprints produced from intercepted documents, means for comparing fingerprints coming from the means for storing fingerprints produced from intercepted documents with fingerprints coming from the means for storing fingerprints produced from sensitive documents under surveillance, and means for processing alerts, containing the references of intercepted documents that correspond to sensitive documents.

8. An interception system according to claim 7, characterized in that it includes selector means responding to the means for processing alerts to block intercepted documents or to forward them towards a second networks, depending on the results delivered by the means for processing alerts.

9. An interception system according to claim 7, characterized in that the centralized system further comprises means for associating rights with each sensitive document under surveillance rights, and means for storing information relating to said rights, which rights define the conditions under which the document can be used.

10. An interception system according to claim 1, characterized in that it is interposed between a first network of the LAN type and a second network of the LAN type.

11. An interception system according to claim 1, characterized in that it is interposed between a first network of the Internet type and a second network of the Internet type.

12. An interception system according to claim 1, characterized in that it is interposed between a first network of the LAN type and a second network of the Internet type.

13. An interception system according to claim 1, characterized in that it is interposed between a first network of the Internet type and a second network of the LAN type.

14. An interception system according to claim 13, characterized in that it further comprises a generator for generating requests from sensitive documents to be protected, in order to inject requests into the first network.

15. An interception system according to claim 14, characterized in that the request generator comprises:
means for producing requests from sensitive documents under surveillance;
means for storing the requests produced;
means for mining the first network with the help of at least one search engine using the previously stored requests;
means for storing the references of suspect files coming from the first network; and
means for sweeping up suspect files referenced in the means for storing references and for sweeping up files from the neighborhood, if any, of the suspect files.

16. An interception system according to claim 7, characterized in that said means for comparing fingerprints deliver a list of retained suspect documents having a degree of pertinence relative to sensitive documents, and the alert processor means deliver the references of an intercepted document when the degree of pertinence of said document is greater than a predetermined threshold.

17. An interception system according to claim 7, characterized in that it further comprises, between said means for comparing fingerprints and said means for processing alerts, a module for calculating the similarity between documents, which module comprises:
a) means for producing an interference wave representing the result of pairing between a concept vector taken in a given order defining the fingerprint of a sensitive document and a concept vector taken in a given order defining the fingerprint of a suspect intercepted document; and
b) means for producing an interference vector from said interference wave enabling a resemblance score to be determined between the sensitive document and the suspect intercepted document under consideration, the means for processing alerts delivering the references of a suspect intercepted document when the value of the resemblance score for said document is greater than a predetermined threshold.

18. An interception system according to claims 7, characterized in that it further comprises, between said means for comparing fingerprints and said means for processing alerts, a module for calculating similarity between documents, which module comprises means for producing a correlation vector representative of the degree of correlation between a concept vector taken in a given order defining the fingerprint of a sensitive document and a concept vector taken in a given order defining the fingerprint of a suspect intercepted document, the correlation vector enabling a resemblance score to be determined between the sensitive document and the suspect intercepted document under consideration, the means for processing alerts delivering the references of a suspect intercepted document when the value of the resemblance score for said document is greater than a predetermined threshold.
